(19) United States
(12) Patent Application Publication
(10) Pub. No.: US 2012/0265586 A1
(43) Pub. Date: Oct. 18, 2012

(54) SYSTEM AND METHOD TO MEASURE AND CONTROL POWER CONSUMPTION IN A RESIDENTIAL OR COMMERCIAL BUILDING VIA A WALL SOCKET TO ENSURE OPTIMUM ENERGY USAGE THEREIN

(75) Inventor: Richard James Mammone, Warren, NJ (US)

(73) Assignee: RUTGERS, THE STATE UNIVERSITY OF NEW JERSEY, New Brunswick, NJ (US)

(21) Appl. No.: 13/294,633

(22) Filed: Nov. 11, 2011

Related U.S. Application Data
(63) Continuation-in-part of application No. 12/883,550, filed on Sep. 16, 2010.
(60) Provisional application No. 61/412,688, filed on Nov. 11, 2010.
(60) Provisional application No. 61/414,785, filed on Nov. 17, 2010.
(60) Provisional application No. 61/415,821, filed on Nov. 20, 2010.
(60) Provisional application No. 61/418,820, filed on Dec. 1, 2010.

(51) Int. Cl. G06F 1/26; G06Q 30/02

(52) U.S. Cl. 705/14.1; 700/292

(57) ABSTRACT

A system and method to measure and control power usage within a residential or commercial building plurality having of electrical circuits electrically connected to an over-current protection device to ensure optimum energy usage therein. The system and method includes a power measurement and control device electrically connected to one of the electrical circuits by which a load draws power that is operable to (i) measure an electrical parameter of the electrical circuits, (ii) compare the measured electrical parameter to an ideal electrical parameter, and (iii) adjust power supplied to one or more of the electrical circuits based on the comparison of the measured electrical parameter and the ideal electrical parameter via a wall socket. The adjustment of power may be automatic or manual deactivation, decrease, and/or increase of power supplied to the electrical circuits via the wall socket so that such is equivalent to or less than the ideal electrical parameter.

### CROSS-REFERENCE TO RELATED APPLICATIONS

This patent application claims priority to and is a continuation-in-part of U.S. Non Provisional patent application Ser. No. 12/883,550 filed Sep. 16, 2010, the entire contents of which is additionally herein incorporated by reference in its entirety. Additionally, this patent application also claims priority to U.S. Provisional Patent Application Ser. No. 61/412,688 filed Nov. 11, 2010, U.S. Provisional Application Ser. No. 61/414,785 filed Nov. 17, 2010, U.S. Provisional Application Ser. No. 61/415,821 filed Nov. 20, 2010 and U.S. Provisional Application Ser. No. 61/418,820 filed Dec. 1, 2010; the entire contents of which are also herein incorporated by reference in their entireties.

### BACKGROUND OF THE INVENTION

Power usage in homes, offices, and other building structures (e.g., residences) are generally used throughout a billing period without a consumer or customer knowing how much the power usage bill will be until a bill from a power company is delivered to the consumer. In many cases, the power or electric bill causes the consumer “sticker shock” due to the power usage being more than anticipated. As consumers and businesses have more electronic devices these days (e.g., large screen televisions, computers, etc.), power usage bills have generally increased over the years and become less predictable.

It has been shown that providing the consumer with real-time or up-to-date (e.g., daily) power usage and/or billing information of power usage that the consumer ends up having a 10% to 20% lower monthly power usage bill. Over the recent past, attempts to provide such information has included using smart meters, power sensors, power meters, and appliance/plug sensors to collect power usage data and provide the consumer with real-time or up-to-date power usage information.

Smart meters are power meters that have “intelligence” built in (e.g., processing system) to be able to collect and communicate power usage data of power used within a residence. Smart meters have been replacing traditional “dumb” power meters that have electromechanic dials, including a large disk, that rotate as power is being consumed. The smart meters enable the power company to read power usage remotely, and may also be used to provide the consumer with real-time or up-to-date power usage information. The smart meters are expensive and require an electrician to install, which further increases the cost.

Power sensors are electronic devices that are typically installed at existing traditional power meters, circuit breakers, or fuse boxes. The power sensors are generally installed directly on high-voltage lines that enter or exit the power meter, circuit breaker, or fuse box. Some power sensors use magnetic sensors that sense magnetic fields generated by the power lines. Power sensors can be expensive because of the electrical components used to produce the power sensors, but are also expensive to install due to an electrician having to perform the installation onto high-voltage lines or within a glass cover of the power meter.

Meter readers generally utilize optical reading devices that are capable of sensing a stripe on a power meter disk that rotates as the power meter senses power usage. The meter reader counts rotations of the stripe and uses the count to calculate the amount of power used by the consumer. The meter reader may be strapped around the glass of the power meter by the consumer. The meter reader generally costs over $100 and requires a basic level of mechanical skill for a consumer to install.

Appliance/plug sensors are devices that are configured to be plugged into a wall socket and have an appliance plugged into the appliance/plug sensor. The appliance/plug sensor is capable of measuring power consumed by the appliance connected thereto and communicate the measured power to a central location, generally local to the appliance/plug sensor (i.e., at the residence). The appliance/plug sensor typically costs about $100. While the appliance/plug sensor requires virtually no skills to install, in order to measure total power consumed in a residence, several thousands of dollars of appliance/plug sensors are required to be purchased so that each appliance may be independently measured.

While the above-described techniques for measuring power in a residence are available and useful to allow a consumer to monitor power usage, each has a shortcoming whether it be cost or consumer installation requirements.

### SUMMARY OF THE INVENTION

To overcome the shortcomings of existing power sensing systems and devices, the principles of the present inventive concept provide for a system and method to measure and control power consumption in a residential and/or commercial building via a wall socket to ensure optimum energy usage of a device connected to the wall socket (i.e., energy usage approximate to usage consumption expectations of the device).

Actual energy usage of the device may be obtained by a socket meter capable of measuring resistance and/or complex impedance of the device as well as additional devices throughout a residential network or other network. The socket meter may also determine total power usage, and take and/or suggest corrective action based on the measurement of devices and/or determined total power usage compared to a predetermined ideal measurement of devices and/or total power usage.

Residence power lines are generally configured to include two circuits or phases that are separated by capacitance at a fuse box or circuit breaker. The socket meter may generate a high-frequency (HF) signal that is communicated onto a power line connected to the wall socket, where the HF signal may cross over the capacitance at the fuse box or circuit breaker as a result of being a high enough frequency so that impedance of appliances on both power circuits can be measured. The socket meter may use coherent or non-coherent measurement techniques. Alternatively, the socket meter may be configured to use reflectometer techniques, using coherent or non-coherent techniques, to measure complex impedance of the appliances on the circuit. In one embodiment, time domain power usage measurements may be made and those measurements may be compared with a power usage “signature” of different appliances to determine type of appliance, make, and possibly model.

In addition to users being able to easily measure power usage, the principles of the present inventive concept provide for a service provider to monitor various parameters of appliances being utilized by a consumer and provide the consumer with information specifically tailored to the residence of the consumer. As described above, complex impedance measurements may be made of appliances connected to electrical outlets in a residence of the consumer by using reflectometer techniques. The power factor which is ratio of the real part (resistance) to the magnitude of the complex impedance of an appliance may be monitored over time, which enables the service provider to track the appliance as it becomes less efficient over time. As with the time domain power usage measurements, the service provider may determine a type of appliance being measured, and possibly make and model, based on the complex impedance characteristics of the appliance. And, as the efficiency of the appliance deteriorates as represented by the power factor decreasing, the service provider may generate an ad for the consumer with potential replacement appliances from one or more sellers, thereby anticipating the consumer's purchasing needs. In one embodiment, the sellers of the potential replacement appliances may be geographically local to the consumer. In addition, the service provider may track rate of power factor decrease as power is applied to the appliance and, if the rate of resistance increases too fast, which may be indicative of the appliance becoming dangerously hot, then the service provider may deactivate power to the appliance and/or notify the consumer and/or emergency personnel (e.g., fire and police) of a potential fire hazard. Additionally, upon determining that the rate of resistance of an appliance is increasing too fast, the present inventive concept may automatically deactivate power to the appliance and/or notify the consumer and/or emergency personnel of a potential fire hazard. In the event that the consumer and/or emergency personnel are notified of a potential fire hazard of an appliance, the present inventive concept is operable to transmit a message with detailed information related to the appliance such as the location and type of appliance and an address of the user (e.g., “the refrigerator on the first floor is overheating at 555 Main St. City, State”). Still yet, the principles of the present inventive concept may provide for generating a map of the consumer's residence and illustrating real-time, up-to-date, and non-real-time power usage of the appliances.

The service provider may collect aggregate data of the appliances and provide the data to manufacturers of the appliances, industry players, and consumers. In one embodiment, the principles of the present inventive concept may track geothermal conditions as well as wind and solar energy for the location as produced by governmental and non-governmental groups, and, based on power usage data collected from the residence of the consumer, determine whether other power sources (e.g., solar panels or wind turbines) would benefit the consumer. The consumer may be provided with a message generated by the present inventive concept with detailed information related to, for instance, a cost/benefit analysis along with advertisement(s) from service providers of the alternative power sources available to the user and potential savings provided by such alternative power sources (e.g., “use of a solar panel on your house yesterday would have generated $30.00 in energy savings”).

One embodiment of a method for measuring power usage within a residence having a plurality of electrical circuits electrically connected to an over-current protection device may include measuring, by a power measurement device electrically connected to one of the electrical circuits by which power loads draw power, an electrical parameter of the electrical circuits. The electrical parameter may be a lumped complex impedance. Alternatively, the electrical parameter may be a complex impedance of individual appliances. The measurement may be of AC voltages that may be utilized to calculate complex impedance. Alternatively, the measurement may be made using a reflectometer technique used to compute complex impedance. A data value representative of power being drawn by the power loads connected to the electrical circuits using the measured electrical parameter may be computed. The data value may be instantaneous power usage based on the measured electrical parameter. An indicia representative of the computed data value representative of the power being drawn on the electrical circuits may be displayed. The display of the indicia may be on a website available for a customer to download and view with a computer or other device that offers internet access (e.g. a smart phone). Alternatively, the display may be on a socket meter connected to a socket in a residence that connects to one of multiple power circuits at the residence. The method may include measuring across the phases of a power network via a phase coupler or wireless communication device to transfer readings across the phases so as to enable measurement of lower frequencies (e.g., at or below 1 MHz). The phase coupler may include a high precision impedance converter system having a frequency generator with an analog-to-digital converter, such AD5934 provided by Analog Devices Inc, which includes a 12-Bit, 250 kSPS analog-to-digital converter (ADC) as detailed in the AD5934 Data Sheet Rev. A, which is incorporated herein by reference in its entirety.

One embodiment of a device for measuring power usage within a residential or commercial building having a plurality of electrical circuits electrically connected to an over-current protection device may include a first circuit configured to generate an alternating current (AC) measurement signal, a second circuit configured to apply the AC measurement signal onto one of the electrical circuits, and a third circuit configured to measure a plurality of AC voltages in response to said second circuit applying the AC measurement signal onto one of the electrical circuits. A processing unit may be in communication with the third circuit, and configured to calculate an impedance of appliances connected to the electrical circuits. The impedance may be a lumped impedance as calculated by the impedances being connected in parallel with one another. An input/output unit may be in communication with the processing unit, and configured to communicate data generated by the processing unit to a remote location via a communications network. The socket device may have an embedded web server which runs a local web site that stores data that has been measured locally and performs calculations of indices derived from the measurement data which can be distributed in addition to the measured data. This web site can be accessed remotely in various ways. The remote access location may be a server configured to collect and process the generated data on a public web site.

One embodiment of method of advertising electrical appliances to potential customers may include monitoring electrical resistance of an electrical appliance over time. A determination that a projected cost for utilizing the electrical appliance over a projected time period based on the monitored electrical resistance will exceed a projected cost for utilizing a replacement electrical appliance over the projected time period may be made and a message or notice that indicates that a user of the electrical appliance will save money by replacing the electrical appliance with the replacement electrical appliance over the projected time period may be generated. The notice may further include a listing of the replacement electrical appliance available for purchase. The listing may include one or more advertisements. The advertisements may be from local advertisers, such as retailers, that sell electrical appliances. The notice may be communicated to the user, as a potential customer of a more energy efficient appliance which can replace their current appliance which shows inefficient use of energy as compared to aggregate data accumulated at the remote site.

The aforementioned object and advantages of the present general inventive concept may be achieved by measuring, by a power measurement device electrically connected to the electrical circuit by which a load draws power, an electrical parameter of the electrical circuit, computing a data value related to power being drawn by the load connected to the electrical circuit using the measured electrical parameter, comparing the computed data value related to the power being drawn on the electrical circuit with an ideal data value to yield comparison data, and/or adjusting power available to be drawn by the load from the electrical circuit if the comparison data indicates that the computed data value is greater than the ideal data value. The adjusting step may include communicating a command to a dimmer switch to cause the dimmer switch to (i) stop power output to the power load connected to the one or more of the electrical circuits, and/or (ii) decrease a maximum power output available to be drawn by the power load or another power load connected to the one or more of the electrical circuits to a limited power output. The limited power output may prevent the power load from drawing power from the electrical circuits or a plurality of electrical circuits at a level that causes the computed data value to exceed the ideal data value.

The method may further include the step of displaying an indicia representative of the computed data value related to the power being drawn on the electrical circuits. The measuring step may include generating a measurement signal at a frequency above a threshold frequency that, when the measurement signal is communicated on the electrical circuit, passes through an electrical component at the overcurrent protection device that is electrically positioned between two of the electrical circuits to another of the electrical circuits, and/or communicating the measurement signal on the electrical circuit. The generating the measurement signal step may include generating the measurement signal between approximately 1 MHz and approximately 30 MHz.

The method may further include the steps of communicating the calculated data value representative of the power being drawn to a remote location from the power measurement device, storing the calculated data value at the remote location, processing the calculated data value to generate at least one statistic, and/or enabling a user to access the calculated data value and generated at least one statistic. The measuring step may include measuring complex impedance on the electrical circuits. The complex impedance may include both real and imaginary parts. The measuring step may be performed using a non-coherent measurement technique or a coherent measurement technique.

The method may further include the steps of communicating a first pulse having a first frequency over the electrical circuit, measuring a first reflectance signal of the first pulse from each load or discontinuity, communicating a second pulse having a second frequency over the electrical circuit, and/or measuring a second reflectance signal of the second pulse from each load or discontinuity. The method may further include the steps of determining resistance of a load on the network, determining that the resistance of the load is at or above a threshold resistance value, and/or notifying a user that the resistance of the load has crossed the threshold resistance value. The method may further include the step of communicating at least one load replacement option to the user.

The measuring step may include measuring complex impedance on the electrical circuits with the complex impedance measured by using an auto balancing bridge circuit, a resonant (Q-adapter/Q-Meter), RF I-V (current-voltage) measurement techniques, network analysis (reflection coefficient) or TDR (Time Domain Reflectometry) complex impedance meter circuit. The measuring step may include (i) obtaining a reflection coefficient at various frequencies, and (ii) transforming the reflection coefficients at the various frequencies from a frequency domain into a distance domain via a numeric transformer (e.g., a Fast Fourier Transform (FFT). The transformation may be accomplished via a Frequency Domain Reflectometer (FDR). Each load may be distinguished from each other based on a distance of each load from the monitor. An impedance profile of each load may be centered at each distance and may be filtered out of a composite waveform. An individual load profile for each load may be translated such that each individual load profile is centered at a distance of zero from the monitor to simulate a measurement that is approximate to each load.

The method may further include the step of transforming the translated profile to a frequency domain via the numeric transformer. The frequency characteristic of each separate load may be made available for scan frequencies used above 1 Mhz. The method may further include the step of extrapolating impedance frequency data to 60 Hz using complex analytic functions which may be rational function, polynomials or other functions commonly used for numeric interpolation and extrapolation. The complex impedance at 60 Hz Z(60 Hz) may be used to calculate the power for each load by P=square(Vrms/|Z(60 Hz)|)*R, Q=square (Vrms/|Z(60 Hz)|*X and the power factor pf=R/|Z(60 Hz)| where R is the real part of Z(60 Hz) and X is the imagery part of Z(60 Hz). The apparent Power S=P+Qj. The method may further include the step of identifying each device in the network by comparing measured parameters of each device to known parameters of known devices. The measured parameters may include a polynomial coefficient (e.g., P and Q) for each load over a duration of its operation (e.g., a day or week) to permit identification or classification of each device connected to the network of the present inventive concept (e.g., an appliance type such as a washing machine or light). The identifying step may include classifying the measured parameters using a pattern recognition method (e.g., K-Means, support vector machine, neural network, or Hidden Markov Model (HMM)) to match each load in the network of the present inventive concept to an appliance representative of each load.

The method may further include the steps of correcting values (e.g., impedance values) of each load previously determined by measuring the reflection coefficient, return loss, standing wave ratio, or input impedance of waveforms that are iteratively regenerated, and/or filtering previously measured values (e.g., impedance values) by comparing characteristics (e.g., inverse filter frequency characteristics of previously measured values) to subsequent waveforms to increase resolution and accuracy or correct previously measured and/or predetermined values. The measuring step may includes (i) measuring complex impedance on the electrical circuits, and (ii) decomposing the measured complex impedance into components representative of individual impedances of each different appliance that loads the network.

The decomposition may be obtained via a network circuit model of the network with resistors, capacitors, and inductors in parallel and series combinations connected by wires with a frequency dependence given by the Skin Effect. The network circuit model has parameters defined by numeric optimization using the measured complex impedance of the network at different frequencies to determine optimum circuit values. The power usage within the network may be determined by converting the network and individual impedances using P=V²/R where V is measured about its nominal of 120 volts.

The method may further include the step of measuring one or more phases of a power network with frequencies at or below 1 MHz via a phase coupler. The phase coupler may include a high precision impedance converter system having a frequency generator with an analog-to-digital converter and wireless communication i/o interface.

The aforementioned object and advantages of the present general inventive concept may further be achieved by providing a device to measure power usage within a residence having a plurality of electrical circuits electrically connected to an over-current protection device. The device may include a first circuit configured to generate an alternating current (AC) measurement signal, a second circuit configured to apply the AC measurement signal onto one of the electrical circuits, a third circuit configured to measure a plurality of AC voltages in response to said second circuit applying the AC measurement signal onto one of the electrical circuits, a processing unit in communication with said third circuit, and configured to calculate an impedance of appliances connected to the electrical circuits, and/or an input/output unit in communication with said processing unit and configured to communicate data generated by said processing unit to a remote location via a communications network. The processing unit may be configured to calculate power usage based on the calculated impedance of the appliances connected to the electrical circuits. The alternating current measurement signal may be above approximately 1 MHz. The second circuit may include a high-frequency filter.

The device may further include a switch operable to control a power level transmitted to one or more of the appliances. The processing unit may be configured to calculate power usage based on the calculated impedance of one or more of the appliances. The first circuit, second circuit, third circuit, and processing unit may be configured to use reflectometer measurement techniques to measure impedance of one or more of the appliances drawing power from one or more of the electrical circuits. The processing unit may be further configured to deactivate or decrease power to one or more of the appliances in the event that a determination is made in which the amount of power being drawn by the one or more of the appliances has crossed a power usage threshold level.

The AC measurement signal may have an amplitude at or below approximately 5 volts. The third circuit may be configured to measure an applied voltage (VA), voltage across a known resistor (VI), and a voltage across an unknown impedance (VZ), where the voltages are AC voltages. The processing unit may be configured to calculate the impedance of the appliances connected to the electrical circuits based on the measured VA, VI, and VZ AC voltages. The first circuit, second circuit, third circuit, and processing unit may be configured to use non-coherent measurement techniques. The first circuit, second circuit, third circuit, and processing unit may be configured to use reflectometer measurement techniques to measure impedance of individual appliances drawing power from one of the electrical circuits. The processing unit may be further configured to generate a notification in the event that a determination is made in which the amount of power being drawn has crossed a voltage threshold level.

The device may include an electronic display in communication with said processing unit. The processing unit may be configured to display an indicia representative of power usage of the appliances on the power circuits.

The aforementioned object and advantages of the present general inventive concept may further be achieved by providing a method to advertise electrical appliances to potential customers, said method including monitoring electrical resistance of an electrical appliance over time, determining that a projected cost to utilize the electrical appliance over a projected time period based on the monitored electrical resistance will exceed a projected cost to utilize a replacement electrical appliance over the projected time period, generating a notice that indicates that a user of the electrical appliance will save money by replacing the electrical appliance with the replacement electrical appliance over the projected time period, the notice further including a listing of the replacement electrical appliance available for purchase, and/or communicating the notice to the user. The communicating the notice to the user may include posting the notice on a website for the user to access. The method may include predicting that a cost to utilize the electrical appliance over a projected period of time will exceed a predetermined threshold dollar value.

The method may include determining that the electrical resistance of the electrical appliance has crossed an electrical resistance threshold level, generating a second notice that indicates that the electrical appliance has crossed the electrical threshold level, and/or communicating the second notice to the user. The method may include determining that a rate of increase of the electrical resistance of the electrical appliance is increasing faster than a threshold rate, generating a second notice that indicates that the electrical appliance has become hazardous, and communicating the second notice to the user. The communicating the second notice to the user may include shutting off or decreasing power to the electrical appliance.

The method may include measuring electrical characteristics of the electrical appliance, determining a brand and model of the electrical appliance based on measuring electrical characteristics or user input, determining other electrical appliances that are ideal replacement electrical appliances for the electrical appliance based on the determined brand and model of the electrical appliance, and/or selecting at least one of the ideal replacement electrical appliances for inclusion in the notice. The method may include determining geographical location of the electrical appliance and identifying other electrical appliance that are deemed to be ideal replacement electrical appliances for the electrical appliance, and/or determining a local retailer that carries at least one of the other electrical appliances that is local to the geographical location. The generating the notice may include generating an advertisement that includes the listing of the replacement electrical appliance. The advertisement may include a name of a retailer that carries the replacement electrical appliance.

The generating the notice may include generating the notice in response to determining that the user will save money over the projected time period (e.g., a time period of 3 years). The database of appliances may be searchable based on performance of each of the appliances as measured by average energy used and efficiency of use based on the average value of the power factor.

The aforementioned object and advantages of the present general inventive concept may further be achieved by providing a method to offer discounts for products or services available from a merchant to a consumer or user. The method may include monitoring electrical power use in a residence of building of the user over a first time period via an energy monitoring system to yield a baseline energy use of the first time period, monitoring electrical power use for the residence or building over a second time period, comparing the electrical power use for the residence or building of the second time period to the baseline energy use of the first time period, determining if the electrical power use of the residence or building is more or less than the baseline energy use, and crediting one or more points to the user if the electrical power use of the residence or building is less than the baseline energy use. The method may include converting the one or more points to a discount on a purchase price of the products or services available from the merchant, or converting the one or more points to a monetary credit applicable toward a purchase price of the products or services available from the merchant.

The method may include comparing the electrical power use for the residence or building of the second time period to a plurality of other individuals in a geographic area that is the same as or different than the geographic area of the user to yield comparison data; and displaying the comparison data to the user to incentivize the user to use energy more efficiently. The comparison data may include an indication to the user that a total energy usage amount of the user during a usage from the first period has decreased relative to individuals in a geographic area that is the same and/or different than a geographic area of the user, and how an amount of the energy usage is independently attributed to the user and/or the individuals in terms of a cost savings total.

### BRIEF DESCRIPTION OF THE DRAWINGS

Illustrative embodiments of the present inventive concept are described in detail below with reference to the attached drawing figures, which are incorporated by reference herein and wherein:

FIG. 1 is an illustration of an illustrative multi-phase power circuit network within a residence;

FIG. 2 is a block diagram of a socket meter connected to a wall socket that is electrically connected to a power circuit of a power circuit network within a building (e.g., a business or residence);

FIG. 3 is an illustration of an illustrative bus impedance as a function of paralleled poly-phase power lines;

FIG. 4 is an illustration of an illustrative linear AC RMS voltmeter circuit;

FIG. 5 is an illustration of an illustrative load impedance circuit schematic; and

FIG. 6 is an illustration of a real and imaginary complex impedance and voltage vectors used to calculate reactance;

FIG. 7 is a graph of an illustrative power signal representative of power drawn by appliances connected to power circuits in a residence;

FIG. 8 is a block diagram of an illustrative socket meter;

FIG. 9A is an illustration of an illustrative network system including an illustrative socket meter connected to a power circuit that connects to a breaker panel of a residence;

FIG. 9B is an illustration of an illustrative network system including an illustrative socket meter connected to a power circuit that connects to a breaker panel of a residence;

FIG. 9C is a flow chart of an illustrative process for measuring and processing electrical parameters of electrical circuits to determine power usage and controlling power available to the electrical circuits;

FIG. 10 is a flow chart of an illustrative process for measuring and processing electrical parameters of electrical circuits to determine power usage;

FIG. 11A is a block diagram of an illustrative network illustrating a service provider that is servicing customers at residences;

FIG. 11B is a block diagram of an illustrative set of software modules that may be executed on the processing unit of FIG. 11A of the service provider server;

FIG. 12 is a flow diagram of an illustrative process for monitoring power usage by measuring resistance of appliances at a residence and communicating a notice to the customer;

FIG. 13 is a screen shot of an illustrative browser interface that illustrates an illustrative website that enables a customer of a service provider to submit preferences for the service provider to provide advertisements to the customer;

FIG. 14 is a screenshot of an illustrative browser interface that includes an illustrative webpage including power usage information, messages/warnings, and advertisements for a customer to view;

FIG. 15 is a screenshot of an illustrative browser interface that includes an illustrative webpage including power usage information, geothermal availability, messages/warnings, and advertisements for a customer to view;

FIG. 16 is a plot illustrating a measured reflection coefficient by a VNA over 917 frequencies between one and thirty MHz;

FIG. 17 is a plot illustrating an inverse Fast Fourier Transform of the reflection coefficient data of FIG. 16 which provides impedance as a function of distance;

FIG. 18 is a plot illustrating a result of processing of the reflection coefficient data of FIG. 17 with spurious data produced from multiple reflections removed and a corrected curve with effects of scattering eliminated;

FIG. 19 is a plot illustrating impedance at a frequency domain of a device;

FIG. 20 is a plot illustrating the impedance of FIG. 19 extrapolated down using a mathematical standard;

FIG. 21 is an illustration of an illustrative network system of devices for measuring and processing a reflection coefficient;

FIG. 22 is a flowchart illustrating a process of the present inventive concept;

FIG. 23 is a flowchart illustrating a process of the present inventive concept;

FIG. 24 is a diagram illustrating a formula of the present inventive concept;

FIG. 25 is a diagram illustrating an expression of the present inventive concept; and

FIG. 26 is a flowchart illustrating an expression of the present inventive concept.

### DETAILED DESCRIPTION OF THE PREFERRED EMBODIMENTS

Reference will now be made in detail to the embodiments of the present inventive concept, examples of which are illustrated in the accompanying drawings, wherein like reference numerals refer to the like elements throughout. The embodiments are described below in order to explain the present inventive concept by referring to the figures.

Determining power usage of a residence, which includes commercial and residential premises, is desirable for a variety of reasons by a variety of parties. For example, consumers who pay for energy usage have a desire to track energy usage between bills to avoid surprise or “sticker shock” when receiving a power bill from an energy service provider. Consumers who want additional fire prevention services and/or emergency personnel (e.g., fire and police) may find the principles of the present inventive concept desirable. Consumers who desire to know if an appliance is becoming inefficient may also have an interest. In addition, service providers that desire to have additional communications with consumers may have an interest. Still yet, advertisers of appliances who desire to reach out to consumers in anticipation of the consumer having to replace an existing appliance due to becoming energy inefficient or broken may have an interest. While the above reasons for the various parties to determine power usage, cost and consumer-friendliness of devices capable of measuring power usage in a residence have been problematic.

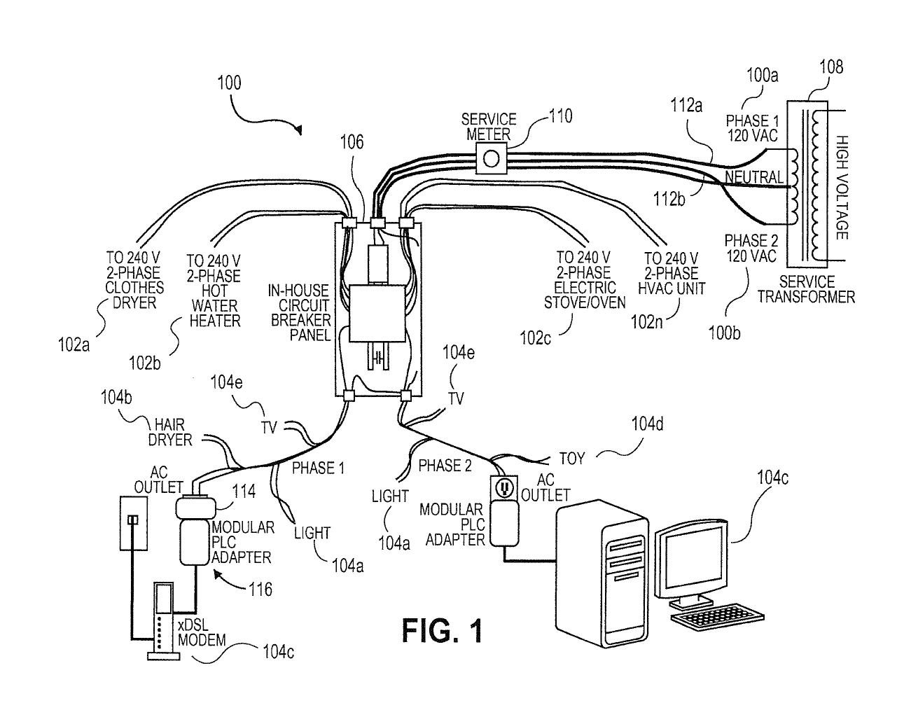

FIG. 1 is an illustration of an illustrative power circuit network 100 used in a building (e.g., residence or business) to power appliances 102a-102n (collectively 102). The appliances 102 may include a clothes dryer 102a, hot water heater 102b, electric oven/stove 102c, and HVAC unit 102n. Other appliances, such as lights 104a, hair dryers 104b, computers 104c, toys 104d, televisions 104e, and any other electrical devices (collectively 104) plugged into the power circuit and are also contemplated for measurement in accordance with the principles of the present inventive concept.

As illustrated, and as understood in the art, the power circuit network 100 includes two phases or circuits 100a and 100b that extend from an over-current protection device, such as a circuit breaker 106. As further understood in the art, a service transformer 108 external from a residence delivers a two-phase 240 volt AC power signal to the residence (not illustrated). Between the service transformer 108 and circuit breaker 106, a service meter 110 is illustrated to be connected to two power lines 112a and 112b from the service transformer 108. The service meter 110 measures overall power drawn from the appliances 102. The service meter 110 is generally a standard or “dumb” service meter that merely measures power usage and has no communication or intelligence capabilities. Smart service meters that have been deployed in recent years have communication ability to report back power usage, but are expensive and have limited capabilities as compared to the principles of the present inventive concept. It should be understood that the availability of a smart meter on a power circuit network at a residence does not preclude the use of a socket meter as described herein or utilization of the principles of the present inventive concept. In fact, certain aspects of the principles of the present inventive concept could be incorporated into a smart meter.

Within the circuit breaker 106 is a capacitance C formed by bus bars with each poly-phase line and conductor. As understood in the art, the capacitance isolates the two phases and prevents DC and low frequency signals from passing between the two circuits 100a and 100b. As a result of the capacitance C, conventional power measurements, such as current measurements using an ammeter, are prevented from being made.

As conventional power measurements cannot be made, the principles of the present inventive concept utilize high frequency signals or tones that are capable of passing through the capacitance C and measuring a resistance and/or an equivalent complex impedance of all the appliances on the two circuits 100a and 100b. The equivalent complex impedance may be used to calculate instantaneous power usage, as further described herein. The high frequency signal may be generated by a socket meter 114 utilizing high frequency (HF) chips that are available for power line communications (PLC). HF chips generally operate between 1 MHz and 30 MHz, which is suitable for the high frequency signal. However, it is generally understood that frequencies about 1 MHz and higher are able to pass through capacitance C and may be used to make the complex impedance measurements with no additional devices needed to measure across the two phases. The present inventive concept measures the total impedance and line voltage to calculate the power usage. The total impedance across both phases can be measured at HF or measured on each phase separately and combined in a central computer. The total impedance can be measured remotely via steady state AC measurements. In an alternative embodiment, rather than measuring an equivalent resistance and/or complex impedance by steady state AC measurements, reflectometer measurement techniques may be utilized to measure impedance characteristics of each appliance on the power line network 100 on an individual basis. The socket meter 114 may be configured to be plugged into a signal socket 116 on one of the power circuits, such as power circuit 100a, and measure resistance and/or complex impedance for calculating power usage by the appliances on both circuits 100a and 100b if the pulses used are modulated to frequencies above 1 MHz.

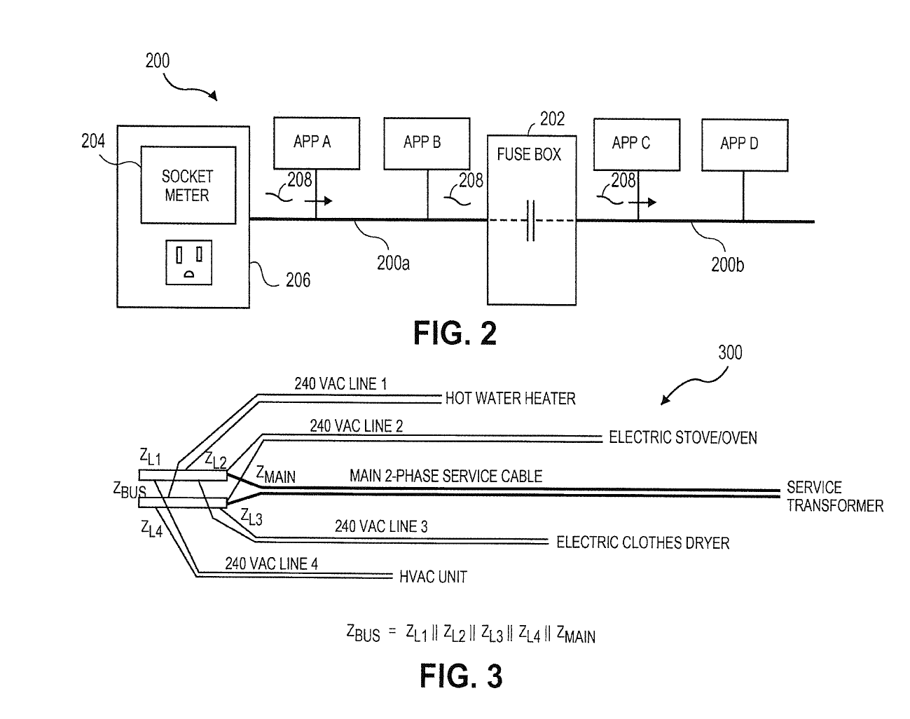

With regard to FIG. 2, an illustrative simplified power circuit 200 is illustrated. The power circuit 200 is composed of two circuits 200a and 200b on different sides of fuse box 202. Appliances (Apps) A and B are connected to power circuit 200a and appliances C and D are connected to power circuit 200b. The power circuits 200a and 200b are electrically separated by capacitance C at DC and low frequencies (below approximately 1 MHz). A socket meter 204 is illustrated to be connected to power socket 206. The power socket 206 may be a conventional power socket that includes two outlets. The socket meter 204 may be configured with either a two or three prong plug to be inserted into the power socket 206 to connect to power circuit 200a.

The socket meter 204 may be configured to convert to 120V AC power from the power socket 206 into a low voltage, high frequency signal 208. The low voltage may be 5V, for example. Other voltages may alternatively be utilized. However, to maintain a low production cost, the use of voltages that comply with standard chip sets (e.g., HF chips) may be utilized. Of course, custom circuitry may alternatively be utilized.

With regard to FIG. 3, an illustration of a representative impedance circuit model 300 of impedances on a power circuit in a residence is illustrated. The impedance circuit model 300 illustrates how lumped impedance Zbus is determined as a function of an impedance of each appliance connected to the power circuit and being electrically connected in parallel with one another.

Zbus=Z_{L1}∥Z_{L2}∥Z_{L3}∥Z_{L4}∥ZMain (1)

From the bus impedance, total power being used by the residence may be computed. The total power may be computed by using the real part of Zbus, which is resistance Rbus, and an actual measured voltage across the socket

As the actual voltage may not be 120V due to variations of loading and other effects, an actual voltage measurement is made. The calculation of total power includes doubling the measured voltage to account for the two phases or power circuits. As understood in the art, power may be calculated as P=V²/R, so in the case of determining total power across the two power circuits in a residence, power is computed by:

Ptotal=(Vsocket)²/R_{bus} (2)

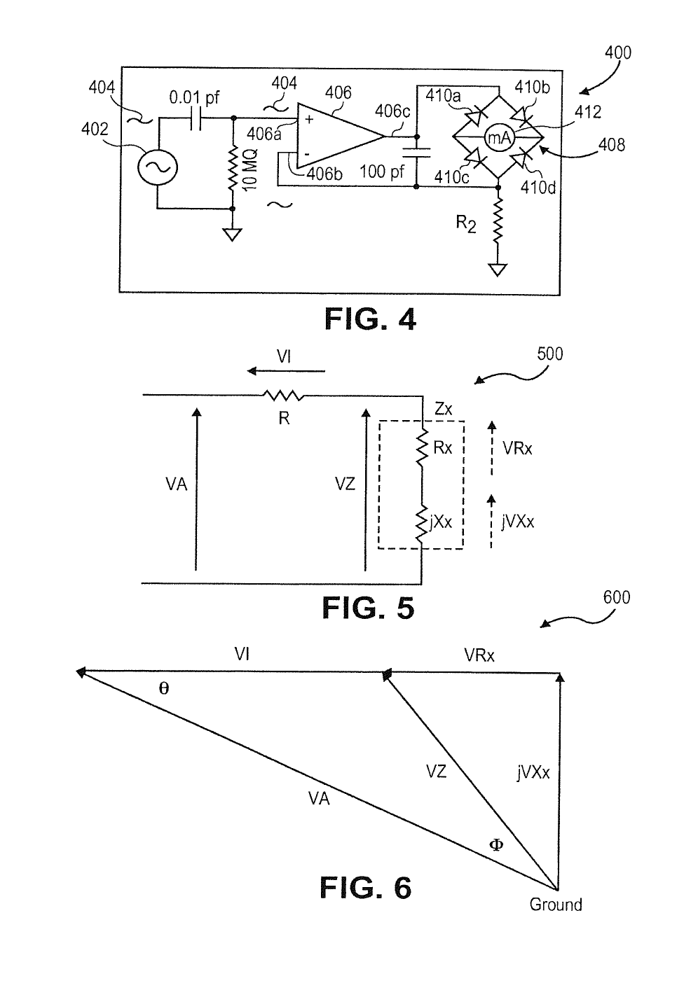

With regard to FIG. 4, an illustrative linear AC voltmeter 400 is illustrated. The AC RMS voltmeter circuit may be used to convert AC voltage into RMS voltage values. It should be understood that the AC voltmeter circuit is illustrative and that alternative AC voltmeter circuits may be utilized.

The AC voltmeter 400 includes a high-frequency voltage source 402 that generates a source signal 404 that is input into a positive terminal 406a of op amp 406. A rectifier 408 includes four diodes 410a 410b, 410c, and 410d. Current flows in or out of the output 406c of the op amp 406, through one of the top diodes 410a or 410b, through meter 412 from right to left, through one of the bottom diodes 410c or 410d, and up or down through resistor R to match the source signal 404. Because the meter 412 and resister R are in series, the same current flows across resistor R as the meter 412, and, as understood in the art, the op amp 406 forces the output voltage at output terminal 406c to make the inverting input voltage let input terminal 406b to the same as the input voltage (source signal 404) on the positive input terminal 406a. The current meter 412 may be calibrated to indicate RMS of a sine wave. In addition, the value of resistor R sets the full range of the meter 412. If a 1 mA meter is used, a 1 volt range is provided. The 100 pF capacitor prevents the op amp 406 to oscillate at high frequencies. However, since the 100 pF capacitor causes accuracy to be lost at high frequencies, this capacitor should be as small as possible while still preventing oscillations. It should be understood that alternative values and configurations may be utilized to provide for the same or equivalent functionality in accordance with the principles of the present inventive concept.

The voltmeter 400 provides for measuring AC RMS voltage in a time domain. The voltmeter 400 may be configured to measure each of the AC voltages, VA, VI, and VZ illustrated in FIG. 5. The voltage Vsocket which is nominally 60 cycle per second 120 volt voltage across the outlet is also measure by RMS. In addition to the three voltages VA, VI, and VZ that are monitored by the voltmeter circuit. These voltages are used to calculate the complex impedance, power, and the complex power (i.e., real and reactance power).

With regard to FIG. 5, a schematic illustrative load impedance circuit 500 is illustrated. The load impedance circuit 500 includes a resistance R at a voltage source and an unknown complex impedance Zx. For RF measurements, the resistance R is typically set to 50 ohms. The unknown complex impedance Zx is composed of a real part (resistance Rx) and an imaginary part (reactance jXx), and is representative of parallel complex impedances as would be positioned on a power circuit, as described in FIG. 3. Complex impedance may be measured by having a known resistance and three AC voltage measurements, in this case VA (applied voltage), VI (voltage across known resistor), and VZ (voltage across unknown impedance). FIG. 6 is an illustration of the real and imaginary complex impedance that may be used to calculate reactance (i.e., capacitance and inductance). Although only magnitudes of the voltages are known, vectors, as illustrated in FIG. 6, may be represented for use in computing the unknown complex impedance values. The law of cosines may be used to calculate the value of angle θ.

$$cos ( θ ) = \frac{V {A}^{2} + {VI}^{2} - {VZ}^{2}}{2 * V A * VI} \qquad ( 3 )$$

From the load impedance circuit 500, the magnitude of the total impedance including R may be calculated as:

Za=R*VA/VI (4)

where VA is the source voltage and VI is the voltage across the resistor R.
The sum of R and Rx can be found by:

R+Rx=Za*Cos(θ) (5)

where θ is illustrated in FIG. 6.
Rx may then be solved for by:

Rx=Za*Cos(θ)−R (6)

Considering possible measurement errors, it is possible that Rx could be computed to be negative, even though unlikely in practice. If such a result does occur, then Rx may be set to zero as the impedance is purely reactive.

The magnitude of the unknown impedance may be calculated as:

Z=R*VZ/VI (7)

The magnitude of the unknown reactance may be calculated as:

Xx=sqrt(Z²−Rx²) (8)

Considering possible measurement errors, it is possible that the square root of a negative number may occur. If such a result occurs, then Xx may be set to zero. The unknown reactance may be used for recognition of a type, make, and model (optional) of an appliance and not necessarily for use in calculating power usage.

As an example of using the above equation to compute the unknown complex impedance, the unknown complex impedance may include a 30 ohm resistor in series with a 60 ohm reactance, which combine to form a 67 ohm complex impedance. If the measurement resistor R is 50 ohms and the applied voltage VA is 1V RMS, the measured voltage VI is 0.5 Vrms and the measured voltage VZ is 0.67 Vrms. The cosine of theta computes to be 0.8. The unknown impedance Zx computes to be 67 ohms, where Rx computes to be 30 ohms, and jXx computes to be j60 ohms. The AC voltmeter may be used to measure the applied AC voltage VA and measured AC voltages VI and VZ. Alternatively, peak-to-peak values or true RMS values could used. It should be understood that magnitude and phase measurements are not necessary for each voltage measurement, which would be more complex and expensive.

In addition to calculating the total power Ptotal (equation (2)), total hub reactance Zhub may be calculated to be used to compute power usage on the power circuit network, where Zhub is calculated by:

Zhub=Rhub+jXhub (9)

The total power Ptotal and total reactance Zhub may be calculated on a regular basis, such as every second, to compute power usage on the power circuit network.

While using high frequency signals allows for measuring impedance (i.e., resistance and reactance) of appliances on multiple power circuits, the use of high frequencies introduces additional complexities in the measurement process. Resistance of wires increases with frequency due to “skin” effect. As an example, resistance of wire at 60 Hz may be close to 1 ohm. However, at 1 MHz, the resistance of the wire at 1 MHz may be significantly higher. Additional resistance of the wire is seen at higher frequencies. As the resistance of the appliances being measured may be in the tens of ohms, skin effect of the wire may make measurement difficult. Skin effect, as understood in the art, causes AC current to flow on the outside of wires. Since the inside of the wires are not used for conducting current, when calculating resistance, as much of the middle of the wires may be eliminated. For copper at 70 C, skin depth in mils is calculated as:

S=2837/sqrt(f) (10)

where f is frequency in Hertz.

The decrease in area of the current flow increases the resistance Rhf over that of the DC resistance of the wires. The relationship of the resistance is proportional to the square root of the frequency and a constant value that depends on the type and combination of types of wire used in the premises when the skin depth squared is much less than the radius of the wire used as in the casse of most residential wiring operating in the range of 1 to 30 Mhz. The relationship is given as:

Rhfwire=Rdcwire×Kwire×sqrt(f)=Khftotal×sqrt(f) (11)

The skin effect resistance problem may be substantially eliminated by performing measurement at two or more different frequencies over the HF frequency range, for example. The two or more measurements are used to form a model of the form:

$$\begin{matrix}Rhf 1 = Rapp + Rwire \times Kwire \times sqrt ( f 1 ) & ( 11 a ) \\ Rhf 2 = Rapp + Rwire \times Kwire \times sqrt ( f 2 ) & ( 11 b ) \\ Rhf 3 = Rapp + Rwire \times Kwire \times sqrt ( f 3 ) \\ ⋮ & ( 11 c ) \\ Rhfn = Rapp + Rwire \times Kwire \times sqrt ( fn ) & ( 11 n )\end{matrix}$$

In one embodiment, a least squares function may be utilized to determine Rapp and Ktotal. Since the power dissipated by the wires is negligible, only the resistance of the appliance Rapp may be retained for further consideration. The skin effect also reduces inductance of the wire, but only by a few percent, which is generally negligible relative to the actual loads. However, this effect could also be corrected in a similar manner to that used for the resistance in certain cases.

The least squares solution for Rx=R0+R1*sqrt(f) may be generalized to many loads that are modeled as a parallel combination of resistor pairs of Ri+Ri+1 sqrt(f). The resistor pairs may be combined using the parallel rule for resistors to form a nonlinear function of resistors and the measurement frequency. The series of nonlinear equations may be solved using well-known methods, such as nonlinear least squares to find the resistor values for each appliance and each length of wire between the appliances. The resulting information can be used to plot a map of power usage within a residence.

The calculations for Rx may be made using linear algebra for each of the frequencies, as provided below:

$$\begin{matrix}[ \begin{matrix}Rx ( 2 ) \\ Rx ( 4 ) \\ Rx ( 6 ) \\ Rx ( 8 ) \\ Rx ( 10 )\end{matrix} ] = [ \begin{matrix}1 & \sqrt{2 \times {10}^{6}} \\ 1 & \sqrt{4 \times {10}^{6}} \\ 1 & \sqrt{6 \times {10}^{6}} \\ 1 & \sqrt{8 \times {10}^{6}} \\ 1 & \sqrt{10 \times {10}^{6}}\end{matrix} ] [ \begin{matrix}{R}_{0} \\ {R}_{1}\end{matrix} ] & ( 12 ) \\ r = XR & ( 13 ) \\ R = {[ {X}^{T} X ]}^{- 1} {X}^{T} r = [ \begin{matrix}{R}_{0} \\ {R}_{1}\end{matrix} ] & ( 14 )\end{matrix}$$

where R₀ is the dc resistance of the load. By measuring complex impedance over multiple frequencies, the portion of the impedance that changes at different frequencies may be determined to be associated with the wires that form the power circuit and be removed from the power usage calculations.

The dc resistance R_{dc} may be used to calculate the power used by all the appliances of the residence, where

power=P=(Vrms socket)²/Rdc (15)

Equation (17) may be used for a socket meter that is plugged into a wall socket that is delivering 120 V AC from one of the phases or circuits of the power circuit network within a residence. If, however, the socket meter or other measurement device in accordance with the principles of the present inventive concept is plugged into a 240 V AC receptacle, then it is noted that the socket device bridges both phases and can use low frequency signals and the voltage will be nominally 240 volts rms rather the 120 volts rms encountered on the single phase more common 120 volt rms socket device.

The volt amperes reactance may be calculated:

Q=(Vrms socket)²/Xx (16)

where the complex impedance is completed by:

Z=R0+jXx (17)

Xx may be measured at a number of frequencies in the HF band and extrapolated down to 60 Hz by finding Xx as a polynomial function of frequency using a least square function in a manner similar to that used to separate out the skin effect. The polynomial model may be justified based on the series expansion of the actual rational function (ratio of polynomials). Volt-ampere reactive (VARs) while not used in residential energy usage, is used for determining energy costs for some commercial customers. Hence, determining complex impedance and VAR power may be provided by the present inventive concept for commercial customer purposes.

As an example of measurements and calculations made using the techniques described above, TABLE I illustrates an illustrative set of measurements and calculations of measured voltages and calculated resistances and complex impedances.

TABLE I
AC Voltage and Impedance Measurements

| f | | | | | | | | | | | |
|---|---|---|---|---|---|---|---|---|---|---|---|
| (MHz) | VA | VI | VZ | VA² | VI² | VZ² | Cos | Za | Rx | Z | Xx |
| 1 | .411 | .294 | .117 | .168921 | .086436 | .013689 | 1 | 71.29592 | 20.29592 | 20.29592 | 7.91e−7 |
| 2 | .401 | .287 | .114 | .160801 | .082369 | .012996 | 1 | 71.25784 | 20.25784 | 20.25784 | 6.31e−7 |
| . . . | . . . | . . . | . . . | . . . | . . . | . . . | . . . | . . . | . . . | . . . | . . . |
| 6 | .335 | .24 | .095 | .112225 | .0576 | .009025 | 1 | 71.1875 | 20.1875 | 20.1875 | 0 |

FIGS. 3-6 and descriptions related thereto provide for a non-coherent technique for determining lump impedance (i.e., each of the appliances in parallel) for calculating power usage in a residence. As an alternative to using the non-coherent technique described above, the principles of the present inventive concept provide for a coherent method, as well. The coherent method may utilize mixers to down-convert the high frequency signal to baseband signals. Such coherent processing techniques of high frequency signals are known in the art. Coherent processing generally costs more money than non-coherent techniques due to more expensive and additional circuitry. One skilled in the art could readily create a circuit to perform coherent measurements may be used to compute impedance and resistance, as described above. The method described here in detail is one method known in the art to measure complex impedance. There are several other known methods that could be used in the present inventive concept for this purpose such as an auto balancing bridge impedance meter circuit, a resonant Q-Meter, RF I-V (radio frequency current-voltage) impedance measurement circuit, Network Analysis (Reflection Coefficient), TDR (Time Domain Reflectometry) or FDR (Frequency Domain Reflectometry) circuits. Any of these techniques can be used to measure complex impedance in the HF frequency range of 1-30 Mhz as used by the present inventive concept.

The measured complex impedance can then be distinguished from each other or “decomposed” into separate components which represent the individual impedances of the appliances which load the network. The network and individual complex impedances are then converted into the network and individual appliance complex power values for the whole building (e.g., an entire residence's or business' network) as well as each appliance individually. For example, one appliance or all appliances in a single network may be monitored using the present inventive concept.

The principles of the present inventive concept provide for performing impedance measurements which can be made using time domain reflectometer (TDR) techniques. To have a reflectometer pulse pass through capacitance at the breaker circuit, the reflectometer pulse may be multiplied or modulated by a high frequency carrier signal above 1 MHz (e.g., between 1 MHz and 30 MHz). Return or reflected pulses from appliances and discontinuities may be demodulated and measured to determine complex impedances. Alternatively, the impedance can measured on each phase using frequencies below 1 MHz and combined in the processor unit using wireless communications or a phase coupler. As with the lump parameter impedance techniques, the reflectometer techniques may utilize non-coherent and coherent measurement techniques, as understood in the art. Reflectometer measurement techniques have an advantage over lump impedance measurement techniques in that the reflectometer technique measures reflections of the reflectometer signal, which means that skin effect of the wire of the power circuit network does not impact the measurements, thereby eliminating having to take measurements at multiple HF frequencies and post processing to eliminate skin effect wire measurements. While the negative impact of skin effect is avoided by using reflectometer techniques to determine impedance and calculate power usage, reflectometer techniques are more difficult and expensive to implement due to rise time of electronics in order to measure reflected signals that are traveling at approximately half the speed of light. However, if produced in bulk, the costs may be reduced on a per unit basis such that the higher, yet economical costs may be worth the improved measurement accuracy over the lump impedance technique.

The present inventive concept is operable to obtain and utilize measurement data in various forms such as, but not limited to, standing wave ratio, return loss, S parameters, reflection coefficient, input impedance, and other like standard measurements that can be made to infer the impedance of a remotely located load on a network and can be modeled as a transmission line, that is, where the cable lengths are larger than one tenth of the signaling wavelengths used. It has been found that this condition holds for residential power lines when the frequency is greater than about 1 Mhz. The measurement data may be provided by the present inventive concept utilizing instruments that yield data at various degrees of specificity, for example, using network analyzers when only the magnitude of the data is desired or Vector Network Analyzers (VNA) when the phase and magnitude of the data is desired.

Alternately, complex impedance can be measured as a function of distance from the meter location in the power line network. Such measurements may be provided by the present inventive concept utilizing instruments such as a Time Domain Reflectometer (TDM) or a Frequency Domain Reflectometer (FDR). The FDR utilizes a Vector Network Analyzer (VNA) which measures reflection coefficient, and a Fast Fourier Transform (FFT) which converts the reflection coefficient from frequency domain to distance domain, which is substituted for time domain. Commercially available devices which provide the reflection coefficient as a function of distance and may be utilized by the present inventive concept to yield such data include the Anritsu Site Master Broadband Cable & Antenna Analyzer S810D, the Agilent N9330B Cable & Antenna Tester, and the AEA Technologies VIA Echo 1000.

The present inventive concept directly measures input impedance via the use of a VNA, a TDR and/or an FDR, and preferably uses the FDR to yield impedance values of a power line so that the impedance values may then be further processed by the present inventive concept as discussed herein. The FDR is preferred because it enables more energy to be transmitted down a cable over a longer period of time, which permits measurement of impedances on a plurality of branch circuits by the present inventive concept. In this manner, the present in inventive concept is able to scan a group of frequencies in sequential steps from a start frequency to an end frequency, as predetermined by a programmer of the present inventive concept and/or an end-user. The ability of the present inventive concept to sequentially scan a group of frequencies advantageously permits frequency dependent attenuation corrections to be made by the present inventive concept with a higher degree of efficiency and specificity relative to other instruments. Output from the FDR permits disaggregation of various loads on the network based on a distance of a device from the meter location. Each impedance of each device, which is identified by the FDR to be for a particular device at a particular distance, is translated to a distance of zero and transformed back to the frequency domain using the FFT. The individual reflection coefficient waveforms are then converted into impedance waveforms by using the relationship Z (w)=Zo [1+Gamma(w)]/[1+Gamma(w)]. The impedance Z(w) is defined only over the frequency ranged used for the original measurement, which is typically in a range of 1 to 30 MHz.

The multiple reflections, which are spaced at integer multiples of the delay of the main pulses, are eliminated since these echoes do not correspond to actual loads. An inverse scattering algorithm is also used to correct the effects of energy loss as more impedance loads are encountered by the propagating waveform. The impedance of each load can be extrapolated down to 60 Hz using a rational function, a polynomial, or other like series that yields a good fit to the data to obtain the impedance at 60 Hz which is denoted by Z. The RMS voltage Vrms is also measured at 60 Hz on a separate channel from the coupler. The real and reactive power and power factor for each load is calculated using P=Square (Vrms/|Z|)*R watts, the reactance power in Square (Vrms/|Z|)*X volt amperes reactance and the power factor pf=R/|Z|. The impedance as a function of frequency Z(w) and P, Q and pf are used as features in a classifier to recognize the type of appliance e.g. washing machine, refrigerator at each location. The classifier is preferably a clustering method such as K-means with a probabilistic model of the transition probabilities between clusters.

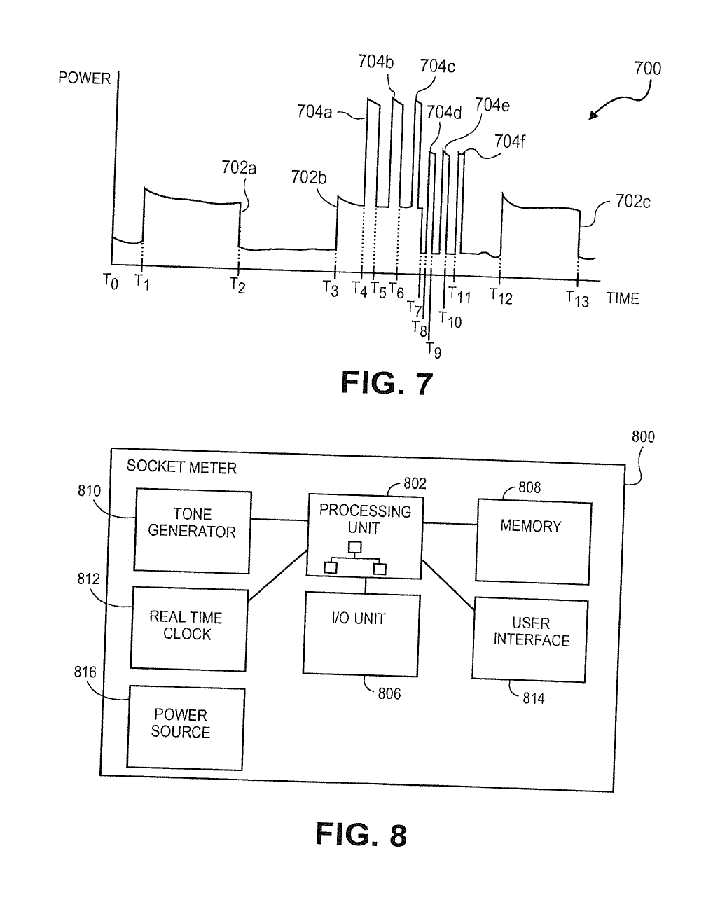

With regard to FIG. 7, a graph of an illustrative power signal 700 representative of power drawn by appliances connected to power circuits in a residence is illustrated. As illustrated, three refrigerator cycles 702a-702c (collectively 702) are illustrated as creating a “square” in the power signal 700 in response to a refrigerator turning on and off. In addition, six heater cycles 704a-704f (collectively 704) in response to a heater turning on and off. Each of the refrigerator and heater cycles 702 and 704 provide a signature for power usage of an associated appliance. It should be understood that the refrigerator and heater cycles 702 and 704 are illustrative and that alternative cycles may be generated depending on appliance, make, and model. In one embodiment, signature signals or curves of cycles of each type, make, and model of appliance may be stored locally on the socket meter or remotely on a server. The stored signature signals may be compared against the measured cycles, thereby enabling determination of the specific type, make, and model of the appliance. As illustrated between times t₃ and t₇, a refrigerator cycle 702b is illustrated to occur along with heater cycles 704a-704c. When the heater cycles 704a-704c occur, the amount of power drawn on the power circuits increases, such that the power usage extends from a top level of heater cycle 702b. In determining which cycles are occurring to determine what appliances are turning on and off and how much power each is drawing, a matching algorithm that is capable of separating and identifying particular cycles in the power signal 700.

With regard to FIG. 8, a block diagram of an illustrative socket meter 800 is illustrated to include a processing unit 802 that executes software 804. The processing unit may be in communication with an input/output (I/O) unit 806, memory 808, tone generator 810, real time clock 812, and user interface 814. The I/O unit 806 may be configured to communicate (i) measurement signals over power lines within a residence and (ii) data communication signals over a communications network, such as a mobile telephone network, Wi-Fi network, the Internet, or any other communications network, as understood in the art. Although not illustrated, it should be understood that the I/O unit 806 may be configured with both analog-to-digital and digital-to-analog circuits to allow for conversion of analog to digital and digital to analog signals, as understood in the art. The memory 808 may be configured to store software and data that is being collected and processed by the socket meter 800. The memory 808 may further be configured to store signature data of appliances to enable the socket meter 800 to be able to determine what specific appliances are operating on the power circuit in the residence in which the socket meter 800 is operating. Alternatively, data that is collected and communicated to a server may be used in determining what specific appliances are operating on the power network in the residence at the server remote from the socket meter 800.

Tone generator 810 may be configured to generate one or more tones above approximately 1 MHz to enable the tones (i.e., signals) to be communicated over the power lines in the residence and through capacitance at a circuit breaker or fuse box. In one embodiment, the tone generator 810 is configured to be able to generate two or more tones (e.g., 2 MHz, 4 MHz, 6 MHz, etc.) at HF frequencies so that the impedance of power lines in the residence as a result of “skin” effect may be calculated, thereby allowing for measurement of the individual impedances of the appliances on the power circuits to be measured along with estimates of the distance between the appliances and the socket used by the present inventive concept.

A real time clock 812 may be configured to operate on the socket meter 800 so that the processing unit 802 may manage dates and times that measurements are made. In one embodiment, the real time clock 812 may be utilized by the processing unit 802 to verify that certain operations (e.g., reporting collected data to a remote server) occur at specific times of the day. Still yet, the processing unit 802 may utilize the real time clock 812 to timestamp dates and times that certain events occur, such as spikes in resistance from an appliance. In one embodiment, the real time clock 812 may be utilized by the processing unit 802 to cause impedance measurements on a periodic basis (e.g., every second).

A user interface 814 may include push buttons, dials, touch screens, or any other user interface element that enables a user to control, program, access data, or otherwise interface with the socket meter 800. User interface 814, for example, may enable a user to set power usage thresholds that, in the event that a total power usage in the residence exceeds a threshold level, the socket meter 800 may generate a notification in the form of an audible, visible, or message form. For example, in the event that over 100 kW are being utilized at any point in time, the socket meter 800 may be configured to communicate an e-mail or text message to the user for notification purposes. Alternatively, the socket meter 800 may generate an audible sound (e.g. beeping sound) to notify the user that excessive power is being drawn by appliances in the residence.

A power source 816 may be configured to power the other components in the socket meter 800. The power source 816 may be configured to convert 120 volt AC power from a wall socket into which the socket meter 800 is connected into 5 volts DC and AC power for driving the other components in the socket meter 800, including powering the tone generator 810 that generates tone signals in the form of 5 volt, HF frequency signals (e.g., 2 MHz). The power source 816 may alternatively be a battery that is rechargeable or non-rechargeable, as understood in the art.

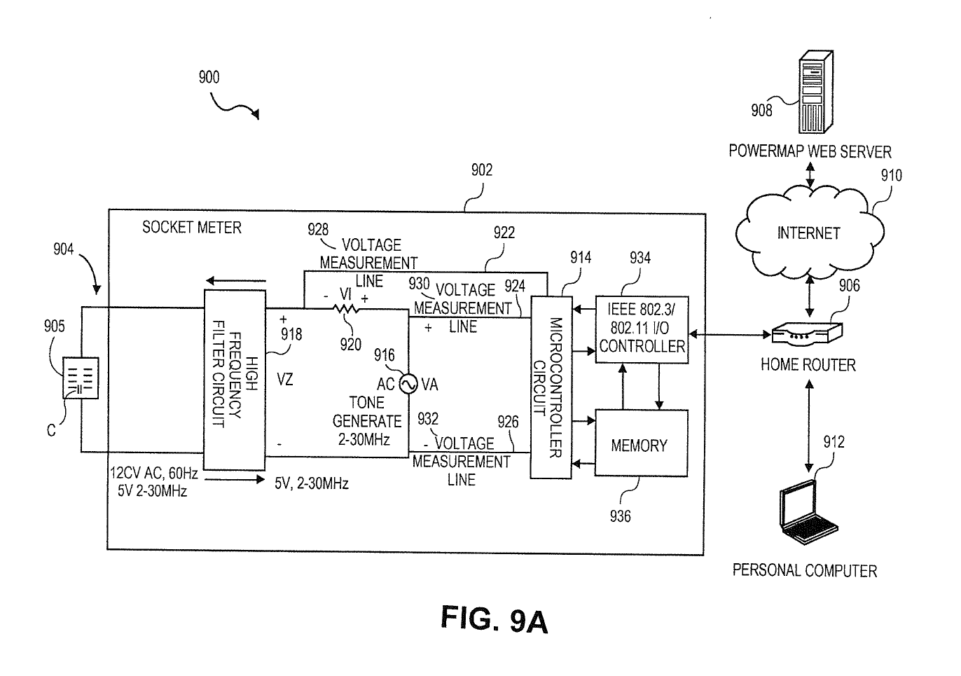

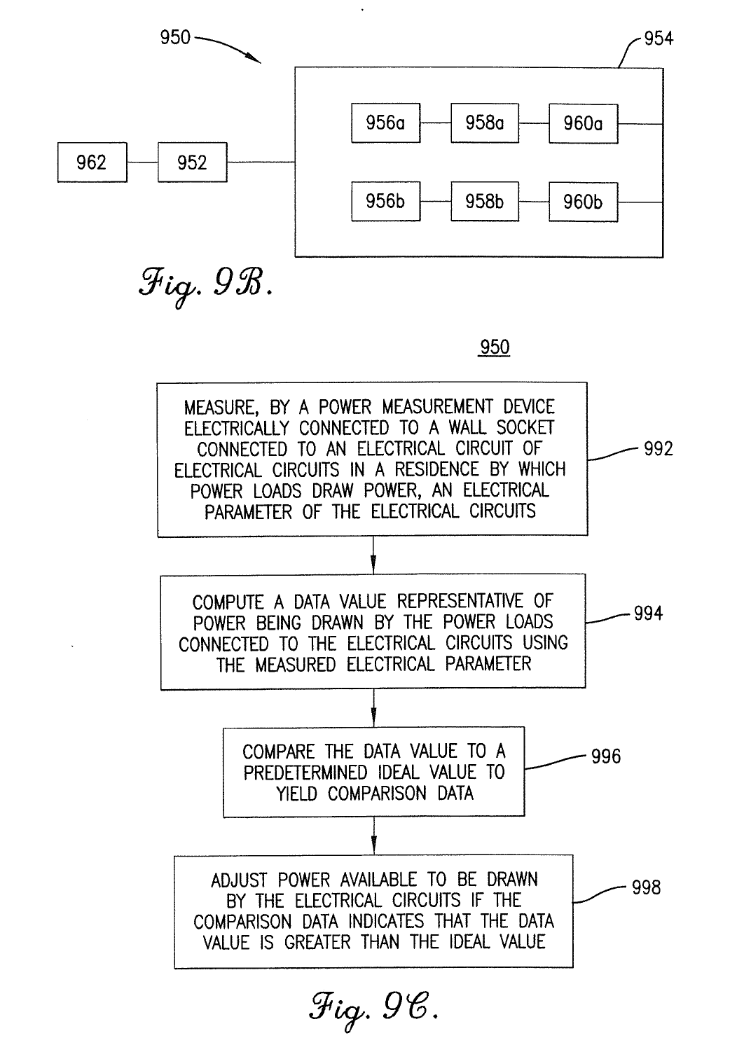

With regard to FIG. 9A, an illustration of an illustrative network system 900 including an illustrative socket meter 902 illustrating an internal schematic, and connected to a power circuit 904 that connects to a breaker panel 905 of a residence is illustrated. In one embodiment, the socket meter 902 may be configured to communicate with a home router 906 for communication with a server 908 via the Internet 910 or any other network. The socket meter 902 may alternatively communicate with a mobile telephone communication system for communicating with the server 908. A personal computer 912 may also be in communication with the home router 906 and configured to display a graphical user interface via a web browser, as understood in the art, configured to receive and display data representative of power utilization at the residence as determined by the socket meter 902 and/or server 908.

The socket meter 902 may include a microcontroller circuit 914 that is configured to control operation of the socket meter 902. The microcontroller circuit 914 may be configured to communicate with a tone generator 916 that generates tones between approximately 1 MHz and approximately 30 MHz. The microcontroller circuit 914 may control or select the frequency at which the tone generator is operating, thereby enabling the microcontroller circuit 914 to selectively set a frequency of a measurement signal to measure impedance of appliances operating on the power circuit 904. It should be understood that the power circuit 904 (e.g., power lines in a house) may include multiple circuits or phases that have a capacitance C between the individual circuits. A high frequency filter circuit 918 may be configured to be in parallel with the power circuit 904 to allow high frequencies (e.g., 1 MHz and higher) to be communicated over the power circuit 904 from the socket meter 902 while reducing frequency signals below high frequencies. A resistor 920 may be placed in series with the tone generator 916 and power circuit 904.

In operation, the socket meter 902 is configured to measure three AC voltage levels, including applied voltage produced by the tone generator 916 (VA), voltage across the resistor 920 (VI), and voltage across the unknown impedance on the power circuit 904 (VZ). As previously described with regard to FIGS. 5 and 6, the magnitude of these three voltages may be utilized to determine both resistance and reactance of the unknown impedance of appliances connected in parallel on the power network 904. Lines 922, 924, and 926 may be utilized to provide voltage measurements 928, 930, 932 to the microcontroller circuit 914. The microcontroller circuit 914 may be configured to process the voltage measurements (i.e., measurements of VA, VI, and VZ) and communicate the voltage measurements via an input/output unit 934, which may be an IEEE 802.3/802.11 I/O controller, via the home router 906 and to the server 908 for further processing. In addition to the voltages that are collected and communicated, the socket meter 902 may further be configured to communicate other data, such as timestamp, impedance, power usage, or any other information that the socket meter 902 may generate or measure. The memory 936 may be configured to store data that is collected, generated, and/or processed for utilization by the socket meter 902 or communication to the server 908 for processing thereat. In one embodiment, the personal computer 912 may be configured to communicate directly with the socket meter 902 for programming or setting certain parameters, such as notification signals, power level alerts, or any other configuration parameters. Alternatively, a customer may interact with a website provided by the server 908 to set configuration parameters and the server 908 may perform a setup of the socket meter 902 to communicating the configuration parameters to the socket meter 902.

With regard to FIG. 9B, an illustration of an illustrative network system 950 including an illustrative controller 952 (e.g., a monitor or processor) connected to a power circuit 954 (e.g., a power line or network at the user's residence or business) of a residence is illustrated. The controller 952 is operable to monitor one or more data values related to power being drawn by one or more devices 956a, 956b (e.g., appliances such as but not limited to a refrigerator and light) in the network 950. The data value may be power consumed by the one or more devices 956a, 956b and/or an electrical resistance of the one or more devices 956a, 956b as measured by the socket meter 902. It is foreseen that the controller 952 may be used in coordination with the socket meter 902 and/or entirely incorporated into the socket meter 902. For instance, the functionality of the controller 952, as described and claimed herein, may be incorporated into the functionality of the microcontroller 914. For purposes of explanation, however, the controller 952, its functionality and related components, are illustrated separately from the microcontroller 914 and its related components.

The controller 952 is additionally operable to independently control via automatic and manual control, power available to the one or more devices 956a, 956b using one or more remotely-controlled switches 958a, 958b (e.g., a plug switch or dimmer switch capable of wireless communication such as X10, Zigbee, or the like) connected to each device 956a, 956b anywhere along the power circuit 954 of the network 950. In the illustrated embodiment, each switch 958a, 958b is respectively plugged into an electrical outlet 960a, 960b (e.g., a standard wall electrical outlet), and each of the devices 956a, 956b are respectively plugged into each of the switches 958a, 958b.

Each switch 958a, 958b is in communication with the monitor 952 and is assignable or set to a specific combination of frequencies that addresses the ACM (Appliance Control Module), when received by the switch 958a, 958b, causes the switch 958a, 958b to adjust a level of power being transmitted through the switch 958a, 958b. In this manner, the combination of the specific frequencies permits control of the switch 958a, 958b. The monitor 958a, 958b is operable to selectively generate the combination of different frequencies (e.g., the address composed of the specific frequencies assigned to one or more of the devices 956a, 956b) and communicate such to the switch 958a, 958b (e.g., wirelessly) to control the switch 958a, 958b. The switch 958a, 958b may be set to the same or different sets of frequencies relative to other switches 958a, 958b to enable independent control of the switch 958a, 958b relative to other switches 958a, 958b. In this manner, the present inventive concept may emit a single tone frequency via the controller 952 to selectively control one or a plurality of switches 958a, 958b. For example, the controller 952 may emit a first tone frequency during a first period to control a first switch 958a and/or a plurality of first switches 958a, 958b, and emit a second tone frequency that is different than the first tone frequency during the first and/or a second period to control a second switch 958b and/or plurality of second switches 958a, 958b.

A user interface 962 (e.g., a computer 912) is employed with the controller 952 to provide two-way communication between the user and the controller 952 (e.g., via a router 906). In this manner, the user may program the controller 952 via the user interface 962 and obtain feedback regarding status of the switch 958a, 958b. The controller 952 is provided with an ideal data value or ideal electrical parameter for each of the devices 956a, 956b (e.g., a maximum power usage level that relates to an optimum power usage as provided by a manufacture of the appliance 956a, 956b). Using the interface 962, the user may set and/or reset the ideal electric parameter. In this manner, if the controller 952 determines that power usage of a certain device 956a, 956b in the user's network 950 is undesirable (e.g., the power consumption is inefficient because is it exceeds the ideal electric parameter), the controller 952 may automatically deactivate power being transmitted to the certain devices 956a, 956b via the circuit 954 by controlling the appropriate switch 958a, 958b (e.g., via generating the tone at the frequency assigned to the appropriate switch 958a, 958b and communicating the frequency to the appropriate switch 958a, 958b). Additionally, the user of the present inventive concept and/or a provider may manually deactivate or decrease power being transmitted to one or more of the devices 956a, 956b and/or set or reset the predetermined level for automatic control by the controller 952 at anytime via the user interface 962.

Each switch 958a, 958b of the present inventive concept is controlled by the controller 952 when the controller 952 is not in scan mode. The controller 952 is generally in scan mode for about five seconds out of every thirty seconds when the controller 952 is activated. Thus, the controller 952 is able to communicate with appliances devices 956a, 956b for about twenty-five seconds out of every thirty seconds so that the user may observe the power usage and efficiency for each devices 956a, 956b online via the user interface 962 in real-time, and observe the automatic execution of actions such as turn on/off or raise/lower the power to each devices 956a, 956b which has the switch 958a, 958b installed between the outlet 960a, 960b and the device 956a, 956b and manually execute actions such as the turn on/off or raise/lower the power to each device 956a, 956b or set/reset of the predetermined levels that govern automatic operation by the present inventive concept.

With regard to FIG. 9C, a flow chart of an illustrative process 990 for measuring and processing electrical parameters of electrical circuits to determine power usage and controlling power available to the electrical circuits is illustrated. The process 990 starts at step 992, where a power measurement device electrically connected to a wall socket that is connected to an electrical circuit of multiple electrical circuits in a residence by which power loads draw power may be utilized to measure an electrical parameter of the electrical circuits. In one embodiment, the electrical circuits include electrical wires to which appliances are connected. The electrical parameter may include complex impedance. The complex impedance may be utilized to compute power being drawn by the electrical circuits (i.e., appliances connected to the electrical circuits). As described herein, the multiple electrical circuits may be connected to a circuit breaker and electrically separated by capacitance at the circuit breaker. The power measurement device may be connected to a single power outlet on one of the circuits and measure the electrical parameter as provided the multiple power circuits (e.g., parallel impedance of appliances on two 120 v AC circuits).

At step 992, a data value representative of power being drawn by the power loads connected to the electrical circuits using the measured electrical parameter may be computed. In computing the data value, measured AC voltages may be utilized to calculate a total complex impedance of complex impedances associated with individual appliances on the electrical circuits. The data value may be a total resistance and/or complex impedance. Alternatively, rather than calculating bulk or total resistance and/or complex impedance, reflectometer measurements may be made and resistance and/or complex impedance may be made on individual appliances. Either coherent or non-coherent measurement techniques may be utilized.

At step 994, a data value representative of power being drawn by the power loads connected to the electrical circuits using the measured electrical parameter may be computed. In computing the data value, measured AC voltages may be utilized to calculate a total complex impedance of complex impedances associated with individual appliances on the electrical circuits. The data value may be a total resistance and/or complex impedance. Alternatively, rather than calculating bulk or total resistance and/or complex impedance, reflectometer measurements may be made and resistance and/or complex impedance may be made on individual appliances. Either coherent or non-coherent measurement techniques may be utilized.

At step 996, the data value representative of power being drawn by the power loads connected to the electrical circuits using the measured electrical parameter is compared to a predetermined ideal value via a processor and/or comparator to yield comparison data. In computing the comparison data, a memory may be used to supply and store the ideal value, and data value, and/or the comparison data.

At step 998, the processor adjusts power available to be drawn by the electrical circuits if the comparison data indicates that the data value exceeds the ideal value. The adjustment may be made via a switch (e.g., Appliance Control Module or dimmer switch) in the electrical circuits, as discussed herein, and may decrease the power available to be drawn to a level necessary so that the data value is equal to or less than the ideal value and/or shutoff the power available to be drawn completely, as also discussed herein.

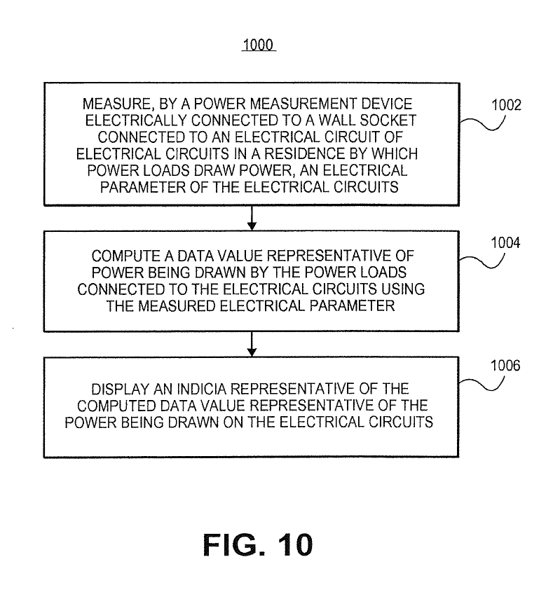

With regard to FIG. 10, a flow chart of an illustrative process 1000 for measuring and processing electrical parameters of electrical circuits to determine power usage is illustrated. The process 1000 starts at step 1002, where a power measurement device electrically connected to a wall socket that is connected to an electrical circuit of multiple electrical circuits in a residence by which power loads draw power may be utilized to measure an electrical parameter of the electrical circuits. In one embodiment, the electrical circuits include electrical wires to which appliances are connected. The electrical parameter may include complex impedance. The complex impedance may be utilized to compute power being drawn by the electrical circuits (i.e., appliances connected to the electrical circuits). As described herein, the multiple electrical circuits may be connected to a circuit breaker and electrically separated by capacitance at the circuit breaker. The power measurement device may be connected to a single power outlet on one of the circuits and measure the electrical parameter as provided the multiple power circuits (e.g., parallel impedance of appliances on two 120 v AC circuits).

At step 1004, a data value representative of power being drawn by the power loads connected to the electrical circuits using the measured electrical parameter may be computed. In computing the data value, measured AC voltages may be utilized to calculate a total complex impedance of complex impedances associated with individual appliances on the electrical circuits. The data value may be a total resistance and/or complex impedance. Alternatively, rather than calculating bulk or total resistance and/or complex impedance, reflectometer measurements may be made and resistance and/or complex impedance may be made on individual appliances. Either coherent or non-coherent measurement techniques may be utilized.

At step 1006, an indicia representative of the computer data value representative of the power being drawn on the electrical circuits may be displayed. In one embodiment, the indicia may be numbers, such as 82 kW. Alternatively, the indicia may be a graph, chart, or any other indicia capable of representing an amount of power being drawn by appliances on the electrical circuits. It should be understood that multiple indicia representative of multiple data that may be collected and/or computed by the socket meter or server with which the socket may be in communication may be displayed. In one embodiment, the display of the indicia may be on a website accessible by a user via a computing device, text message that may be communicated to a mobile device of a user, e-mail message containing the indicia, or any other form of display, as understood in the art.

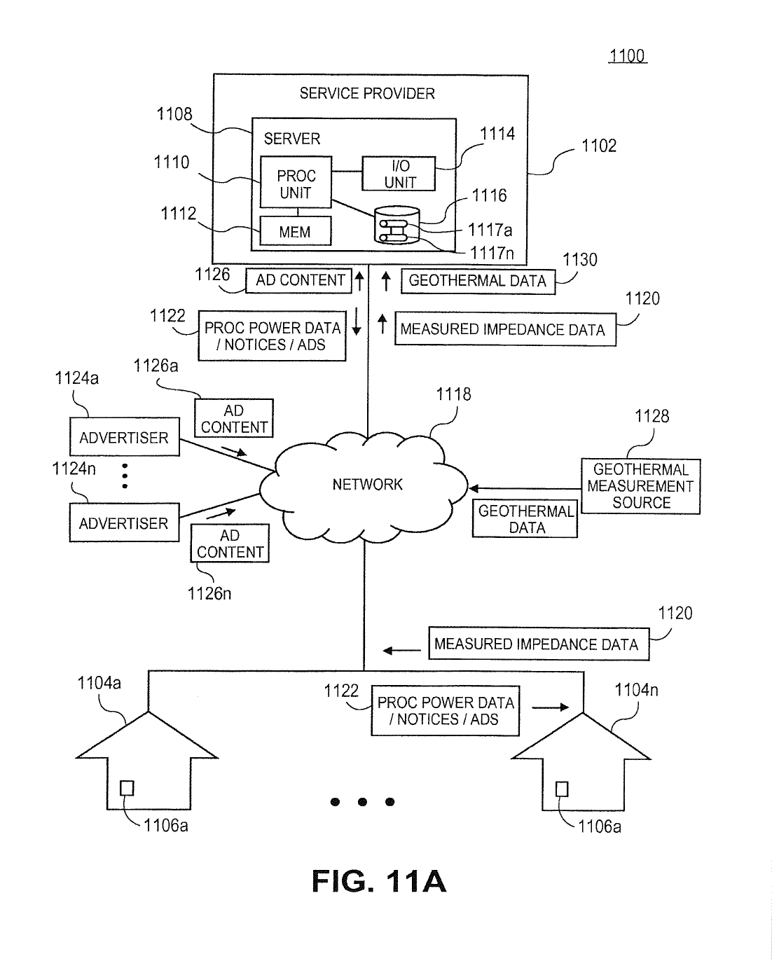

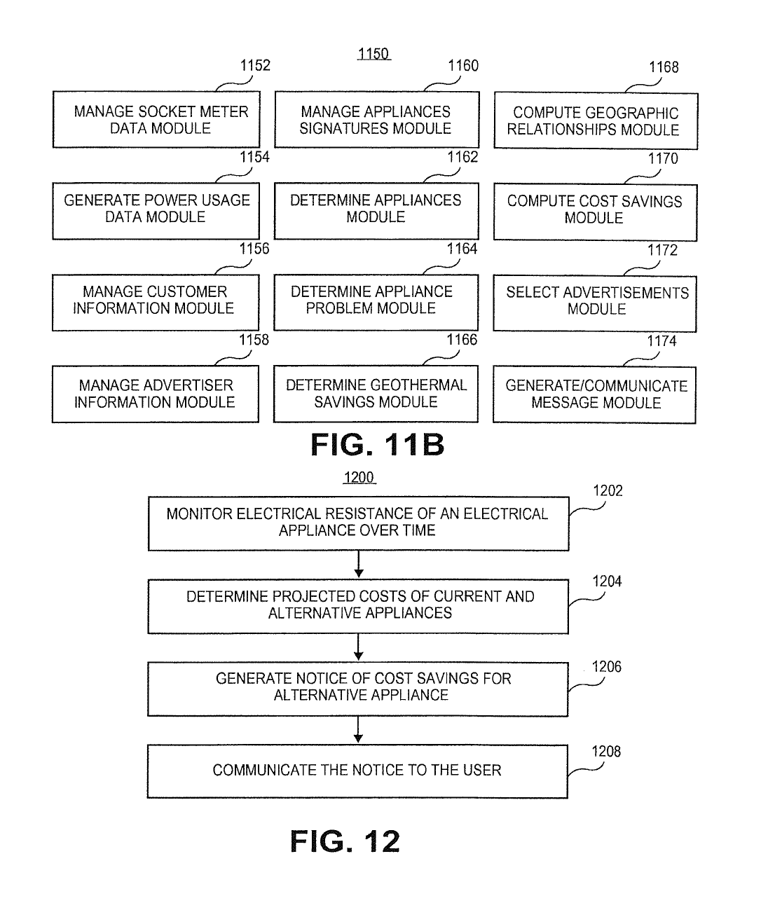

With regard to FIG. 11A, a block diagram of an illustrative network 1100 illustrates a representation of a service provider 1102 that is servicing customers at residences 1104a-1104m (collectively 1104). Each of the residences 1104 includes a socket meter 1106a-1106n (collectively 1106) that is connected to a power circuit within respective residences. The socket meters 1106 may be configured to measure resistance and/or complex impedance of appliances that are being powered by power circuits in the residences. As described herein, the socket meters 1106 may be configured to utilize HF frequencies to measure the complex impedances on multiple power circuits using impedance measurement techniques or reflectometer impedance measurement techniques.

The service provider 1104 may be a power company, third party, or any other service provider that may provide a service of determining power consumption at a residence and deliver advertisements to customers based on power consumption and performance of appliances as measured by the socket meters 1106. The service provider 1102 may operate a server 1108. The server 1108 may have a processing unit 1110 that includes one or more computer processors that executes software (not illustrated) configured to process data received by the socket meters 1106. The processing unit 1110 may be in communication with a memory 1112 that stores software instructions and data collected and/or processed by the processing unit 1100.

The processing unit 1110 may further be in communication with an input/output unit 1114 and storage unit 1116. The I/O unit 1114 may be configured to communicate with the socket meters 1106 via a communications network 1118, such as the Internet. The storage unit 1116 may be configured to store one or more data repositories 1117a-1117n (collectively 1117) that may be configured to store signature data of power usage by specific types, makes, and models of appliances, customer information, advertising information, geothermal information, and any other information in accordance with the principles of the present inventive concept. For example, the customer information may include a history of data, power usage by customers and appliance performance history data that allows the service provider 1102 to track performance of individual appliances of individual customers so that efficiency of the appliances may be tracked. For example, resistance of a washing machine may be tracked over time so that the service provider 1102 may determine when the power factor, which is indicative of inefficiency, of the washing machine increases to the point that the washing machine should be replaced. In addition, if the resistance increases too much or too much over an initial startup phase, then a determination may be made that the washing machine may be becoming a potential fire hazard and the service provider 1102 may generate a notice or alert to the customer of the situation in addition to providing one or more advertisements to the customer of potential replacement washing machines by local or non-local advertisers.

In operation, the socket meter 1106n may measure impedance data 1120 of appliances operating on the power circuits of the residence 1104n and communicate the measured impedance data 1120 via the network 1118 to the service provider server 1108. If the socket meter 1106n calculates power usage based on the impedance data 1120, the power usage data may be communicated to the server 1108 with or without the measured impedance data 1120. The service provider server 1108 may receive the measured impedance data 1120 and process that data to generate processed powered data (e.g., instantaneous power usage, average power usage, wanting total power usage, etc.), notices (e.g., notification that one or more appliances are becoming inefficient or have crossed a threshold level of inefficiency as compared to a new appliance), and advertisements e.g., ads of specific appliances that, as a result of measurements made by the socket meter 1106n. The data 1122 may be communicated back to the socket meter 1106n, display device within the residence 1104n, mobile device of a customer, or webpage of the customer as provided by the server 1108. The data 1122 may be automatically communicated or pushed to the customer or pulled by the customer from the server 1108.

Advertisers 1124a-1124n (collectively 1124) may interact with the service provider 1102 to provide the service provider with advertising information that may be used to deliver notifications of appliances that are available for purchase by customers that have inefficient or broken appliances. The advertisers 1124 may provide the service provider 1102 with address information (not illustrated) and ad content 1126a-1126n (collectively 1126). In one embodiment, the processing unit 1110 may use customer information, including geographic address or location, and determine advertisers that are local to the customer in need of a new appliance. The server 1108 may generate or include one or more advertisements that include information of the advertisers local to the customer in response to determining that an appliance of the customer is becoming inefficient or that the customer may save a certain amount of money over a certain period of time should he or she replace an existing inefficient appliance based on power pricing, appliance power usage, cost of a new appliance, or any other factor.

The principles of the present inventive concept further provide for a geothermal source 1128, such as the U.S. Government, that collects geothermal data 1130, such as sun and wind data, on a regional basis to provide the geothermal data 1130 to the service provider server 1108. the server 1108 may be configured to receive ad content 1126 from advertisers 1124, which may be the same or different from advertisers of appliances, to determine how installing geothermal power sources, such as solar panels or wind turbines, could save a customer money. The determination may be customized based on geographic location of the customer and local suppliers of the geothermal power sources.

In addition to the service provider 1102 collecting and processing data for individual customers in residences 1104a, the principles of the present inventive concept provide for the service provider 1102 to track data in the aggregate. As the service provider 1102 receives data of specific types, makes, and models of appliances, the service provider 1102 may process that data to produce aggregate data that illustrates a variety of parameters, include average duration of time before an appliance make and model becomes inefficient (e.g., greater than 25% inefficient as compared to being new), actual average power usage of specific appliances, and so on. The resulting aggregate data may be used for both commercial and consumer purposes. For example, a manufacturer may desire to determine how its appliances operate in the “field” over time. A manufacturing industry group may desire to access statistics of its manufacturing members for industry trends or other purposes. Consumers may desire to access this information to identify how certain brands and models perform over time. Insurers or warranty companies may desire this aggregate information to set warranties that will be prices correctly and established for a certain duration of time. The aggregate data may be available for purchase or freely available.

With regard to FIG. 11B, a block diagram of an illustrative set of software modules 1150 that may be executed on the processing unit 1110 (FIG. 11A) of the service provider server 1108. The software modules 1150 may be configured to enable the server 1108 to manage and process power usage data, such as appliance impedance data, collected by a socket meter. The software modules 1150 may further be configured to generate and communicate messages to a customer based on a variety of factors, such as geographic distance between the customer and advertiser of an appliance. For instance, the software modules 1150 may selectively organize and display ads to the consumer based on proximity to the consumer to enable the consumer to patronize a seller that is geographically local to the consumer. In this manner, an ad from a seller that is geographically local to the consumer may be listed before an ad from a seller that is not geographically local to the consumer.

A manage socket meter data module 1152 may be configured to manage data that is collected and/or generated by socket meters at residences of customers. The module 1152 may be configured to received and store the data so that other modules may process the data and so that the service provider may access the “raw” data at a later point in time for historical and other purposes.

A generate power usage data module 1154 may be configured to generate power usage data based on data received from socket meters. The module 1154 may, for example, compute instantaneous power usage, average power usage, cumulative power usage during a billing cycle, or any other power usage metrics of which the customer, service provider, advertisers, manufacturers, industry, or any other party may be interested.

A manage customer information module 1156 may be configured to store customer information. The customer information may include name, address, geographic coordinates, demographic, or any other information associated with the customer. Geographic coordinates may be used to determine distance from the customer that advertisers are geographically located so that relevant advertisements for replacement or other appliances may be sent to the customer.

A manage advertiser information module 1158 may be configured to manage information associated with advertisers. The information may include physical address information, contact information, website information, geographic coordinate information, and any other information. In addition, the module 1158 may be configured to manage advertisements of appliances associated with advertisers. In one embodiment, the advertisements may include appliances information, current pricing of the appliances, electrical performance of the appliances, physical configuration of the applications, and so forth. The information associated with the appliances, such as pricing, may be used in determining whether the appliance would save the customer money in replacing an inefficient appliance. In one embodiment, rather than advertising appliances, the advertiser may be an advertiser of geothermal devices that use replenishable sources of energy, such as solar.

A manage appliances signatures module 1160 may be configured to manage power usage signatures of types, makes, and models of appliances. In managing the power usage signatures, the module 1160 may be configured to store the signatures in a data repository, such as a database, in an organized manner. For example, the data repository may be configured to store the signatures by appliance type, appliance make (manufacturer), appliance model, or any other configuration. The signatures may be used for identifying the type of appliance that is drawing power. A signature may be a waveform. Alternatively, the signature may be data representative of complex impedance.

A determine appliances module 1162 may be configured to specifically identify appliance type, make, and/or model. The identification of the specific appliances that are being measured at a residence may use a variety of pattern matching or comparison techniques. For example, the same, analogous, or modified comparison techniques may be used to determine appliances as used in speech recognition. In one embodiment, pattern matching to power usage signatures may be utilized. Alternatively and/or additionally, complex impedance matching may be performed. It should be understood that a variety of identification techniques may be utilized in accordance with the principles of the present inventive concept. As an alternative to automatically identify appliances using power usage signature matching, the customer may provide a list of appliances at the customer's residence and the determine appliances module 1162 may simply look-up the signature.

A determine appliance problem module 1164 may be configured to determine an appliance problem with appliances on the power circuit network at a residence of the customer by comparing specification operating parameters as defined by a signature or other specifications, as understood in the art. The module 1164 may be configured to determine a number of parameters, including operating performance, inefficiency, potential fire hazard, and other problems. In response to determining that a problem exists, the module 1164 may update a data repository or notify another module directly to cause a notification, alert, or alarm to be generated to notify the customer.

A determine geothermal savings module 1166 may be configured to access geothermal information accessible by the server 1108 that provides for geothermal information in a geographic area in which a customer resides. The module 1166, based on an amount of energy used to heat or cool the residence of the customer, may determine how much money the customer could save by installing a geothermal energy production device, such as solar panels. The cost savings may include cost of the geothermal energy production device, installation costs, and cost savings. In addition, the cost of electricity being paid by the customer may be factored into the calculations.

A compute geographic relationships module 1168 may be configured to compute a distance between a customer and advertisers of appliances. If the customer desires to receive advertisements from local advertisers, then a distance from the customer's residence to a store of the advertiser may be computed to determine whether the advertiser is local. The module 1168 may itself perform the distance calculation or the module 1168 may invoke a distance calculation system (e.g., MapQuest® mapping system) remotely located from the server 1108.

A compute cost savings module 1170 may be configured to use power usage information of an appliance and determine whether the customer would save money over time (e.g., 1 year) by replacing the appliance with an energy efficient appliance. In determining the cost savings, the module 1170 may use the current energy pricing (e.g., $0.12/kWh) and compare to actual power usage of the appliance with specifications of the new appliance.

A select advertisements module 1172 may be configured to select particular advertisement(s) to present to a customer depending on whether the customer can save money over a certain time period (e.g., 3 years) by replacing an existing energy inefficient appliance. In addition, if it is determined that an existing appliance is becoming a fire hazard, an advertisement from an advertiser may be selected and sent to the customer. In one embodiment, the advertisements may be local to the customer. The advertisements may be of appliances that are the same or equivalent makes and models to the appliance that is energy inefficient. A variety of factors may be used, including using the customer's profile, to select how many and which advertisements are to be sent. The module 1172 may select repair advertisements if it is deemed that the appliance, such as a washing machine, could be fixed or adjusted to correct for energy inefficiency.

A generate/communicate message module 1174 may be utilized to generate and communicate messages. In one embodiment, the messages may include advertisements. The messages may provide for real-time, up-to-date, or current monthly total power usage. The messages may further include information about specific appliances, such as “Your refrigerator is now 30% below original energy usage efficiency.” The messages may also include alerts, such as “There is a potential fire hazard with your air conditioner.” The messages may be posted to a website or a widget for the customer, communicated over a communications network (e.g., email, text message), mailed, placed over a telephone line, or any other means for communicating information to the customer. In another embodiment, a mobile device application may be used to enable the customer to receive or request up-to-date power usage or other information in accordance with the principles of the present inventive concept.

It should be understood that the modules 1150 are illustrative and that alternative and/or additional modules may be utilized in accordance with the principles of the present inventive concept. Still yet, the modules 1150 may be combined or segmented into distinct modules to provide for functionality as described herein.

With regard to FIG. 12, a flow diagram of an illustrative process 1200 for monitoring power usage by measuring resistance of appliances at a residence and communicating a notice to the customer is illustrated. The process 1200 starts at step 1202, where electrical resistance of an electrical appliance may be monitored over time. The electrical resistance may be a real part of a complex impedance measured of an appliance. In one embodiment, the measurement may be performed using bulk impedance measurements, either coherent or non-coherent, or reflectometer techniques, either coherent or non-coherent, to measure individual appliances on the power circuit network as understood in the art. The measurements may be made utilizing HF frequencies, as previously described herein. As step 1204, projected costs of current or existing and alternative appliances may be determined. The projected costs may be based on current power usage by each of the appliances based on resistance of the appliances. The determination of the projected cost may be projected out one or more years to determine how much more energy an existing, inefficient appliance will use over a new appliance. In one embodiment, the new appliance may be the same make and model. However, it should be understood that the principles of the present inventive concept provide for determining a difference in energy usage over time of an existing appliance being utilized by a customer versus a new, efficient appliance.

At step 1206, a notice of cost savings for an alternative appliance may be generated. The notice of cost savings may include a cost savings over time (e.g., three years), where the cost savings may be at or above a certain threshold level based on a customer's desire for receiving a notice before the notice is to be sent. At step 1208, the notice may be communicated to the user. The notice may be in the form of posting on a webpage or sending an electronic message to the customer. Still yet, the notice may be in the form of a telephone call that presents a synthesized or actual person's voice to the customer to notify the customer of the potential cost savings should the customer replace the inefficient appliance with an efficient appliance.

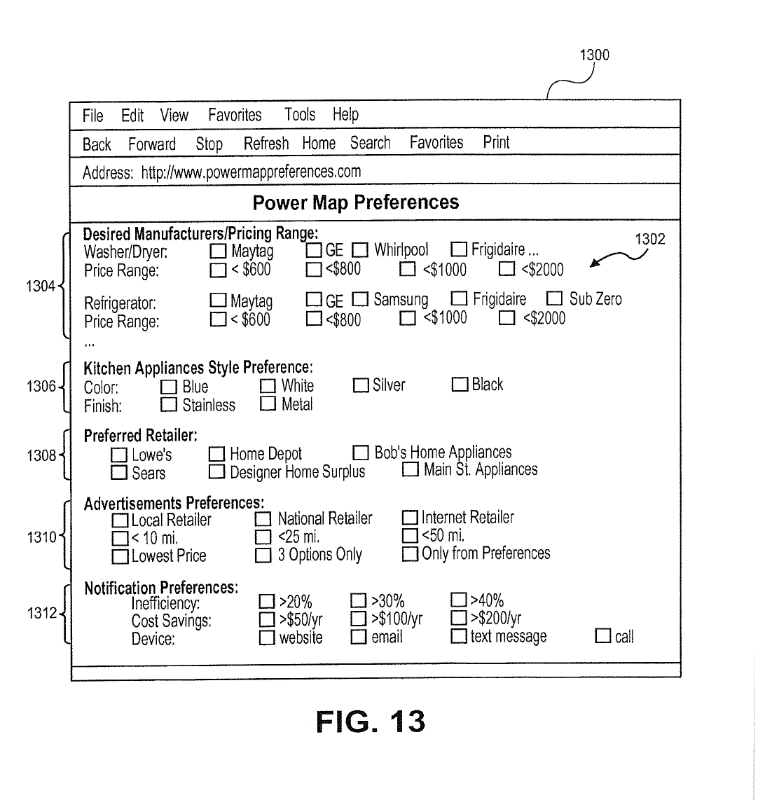

With regard to FIG. 13, a screen shot of an illustrative browser interface 1300 illustrates an illustrative website 1302 that enables a customer of a service provider to submit preferences for the service provider to provide advertisements to the customer in response to determining that an appliance may need to be repaired based on becoming inefficient or newer appliances may save the customer money over time due to being more efficient in using less power. The website 1302 may include a desired manufacturers price range section 1304 in which a customer may select desired manufacturer(s) and price range of specific appliances (e.g., washer/dryer, refrigerator, etc.). The manufacturers may be brand name manufacturers and the price ranges may be low cost appliances up to expensive appliances within each appliance type. A kitchen appliance style preference section 1306 allows a customer to select kitchen appliance style, including color and finish. A preferred retailer section 1308 allows a customer to select preferred retailer(s) from which the customer desires to receive advertisements in the event that the service provider determines that an appliance of the customer is inefficient or other appliances may allow the customer to save money through power usage savings.

An advertisements preferences section 1310 may enable a customer to select advertisement options, which may include local retailers, national retailers, Internet retailers, retailers that are within 10 miles of his or her residence, within 25 miles of his or residence, within 50 miles of his or her residence, lowest priced appliance, three options only of an appliance for replacement, only advertisements that meet the preferences selected by the customer. A notification preference section 1312 may allow a customer to select notification options, where the notification options or preferences may include inefficiency or cost savings options. In one embodiment, the cost savings may be on an annual basis. Alternatively, the cost savings may be on a multi-year basis. Still yet, the cost savings may be computed based on replacement cost of the appliance plus power usage costs for using the newer appliance. For example, if an existing appliance is to cost $1200 over the next three years of power usage and a new appliance costs $500 and the customer will only use $500 of energy based on the new appliance being more energy efficient, the cost savings will be $200 over the next three years. The notification preferences may also include notification devices to which the notices and/or alerts are to be communicated to the customer.

It should be understood that the website 1302 is illustrative in that each of the sections and selectable options within the sections may be different than those illustrated herein. It should further be understood that alternative options and preferences may be provided to the customer for selection of how the customer is to be notified what content is to be delivered to the customer in the notifications, power usage data that is to be computed and reported, or any other information in accordance with the principles of the present inventive concept.

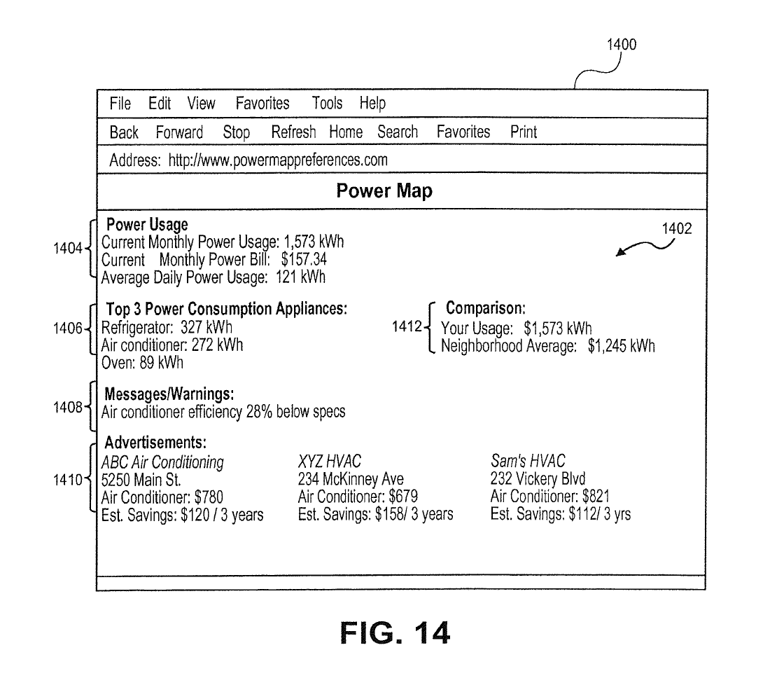

With regard to FIG. 14, a screenshot of an illustrative browser interface 1400 is illustrated to include an illustrative webpage including power usage information, messages/warnings, and advertisements for a customer to view. The webpage 1402 may include a power usage section 1404 that displays current monthly power usage, current monthly power bill, and average daily power usage. Other power usage data may be provided to the customer. A top three power consumption appliances section 1406 may present the top three power consumption appliances in a residence of the customer. For example, as illustrated, a refrigerator has currently consumed 327 kWh during the month, air conditioner has consumed 272 kWh during the month, and oven has consumed 89 kWh during the month. By providing the top three power consumption appliances, the customer may become sensitive to efficiency of these appliances or usage of optional appliances (e.g., hair dryers). A messages/warnings section 1408 may provide a message of inefficiency or otherwise to a customer. For example, in the event that an air conditioner is becoming inefficient, a message may be displayed that the air conditioner is a certain percentage of efficiency below its original specs.

An advertisements section 1410 may be configured to display advertisements from advertisers that sell appliances that are becoming inefficient or can provide cost savings for the customer over a certain time period. As illustrated, three advertisements are provided from local, national, and/or Internet sellers of air conditioners. In addition, the advertisements may list prices of a new air conditioner that may be the same make and model or different make and model than that currently owned by the customer and estimated cost savings over a certain time period (e.g., three years). The advertisements may be selectable to enable a user to automatically be linked to the advertiser's website to view the specific air conditioner available for sale and purchase the air conditioner from the advertiser either via the website and/or provide contact information for the advertiser to enable the customer to determine location of the advertiser for visiting the retail store of the advertiser.

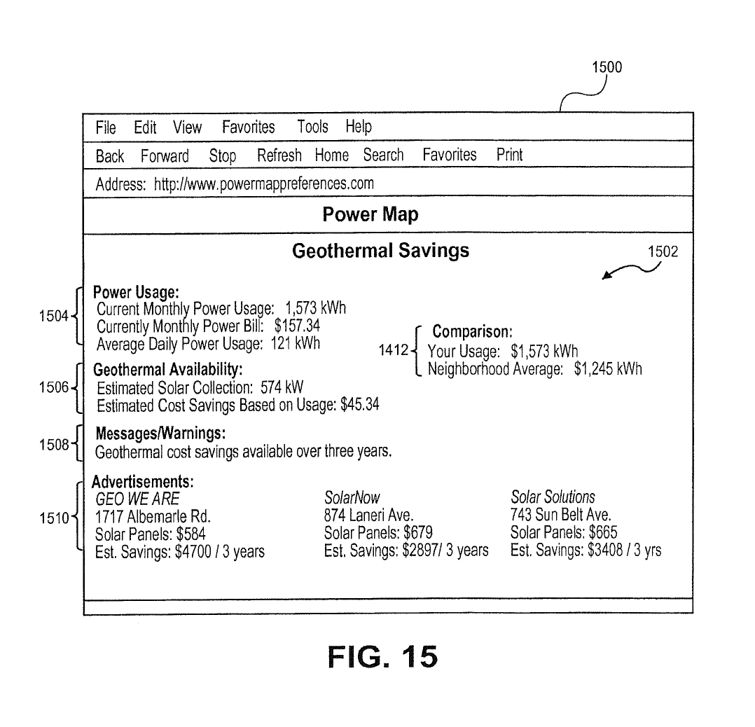

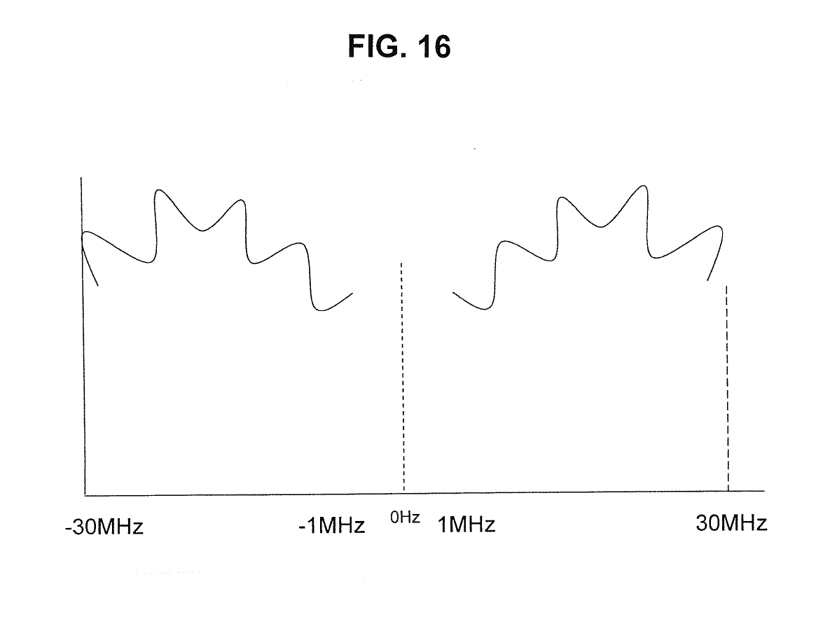

With regard to FIG. 15, a screenshot of an illustrative browser interface 1500 is illustrated to include an illustrative webpage including power usage information, geothermal availability, messages/warnings, and advertisements for a customer to view. The webpage 1502 may include a power usage section 1504 that displays current monthly power usage, current monthly power bill, and average daily power usage. Other power usage data may be provided to the customer. A geothermal availability section 1506 may present the customer with power and cost savings if geothermal devices are installed at the residence of the customer. For example, if solar collection were installed, 574 kW could be collected and a cost savings of $45.34 is estimated to occur. A messages/warnings section 1508 may provide a message of inefficiency or otherwise to a customer.

An advertisements section 1510 may be configured to display advertisements from advertisers that sell appliances that are becoming inefficient or can provide cost savings for the customer over a certain time period. As illustrated, three advertisements are illustrated from local advertisers. It should be understood that advertisements from national and/or Internet sellers of solar panels may be provided, as well, depending on customer preferences. In addition, the advertisements may list prices of new solar panels may be provided. In addition, estimated cost savings of the solar panels may be illustrated. It should be understood that alternative geothermal devices that can help a customer save money may also be available for presenting advertisements to a customer. The advertisements may be selectable to enable a user to automatically be linked to the advertiser's website to view the specific solar panels available for sale and purchase the solar panel from the advertiser either via the website or enable the customer to determine location of the advertiser for visiting the retail store of the advertiser.

It is foreseen that, upon request by the user, the present inventive concept may analyze all appliances in view of criteria selected by the user, and produce a report. For instance, the user may request a report listing a directory of the appliances in the network in numerical order based on one or a combination of the following: (i) average energy consumed by each of the appliances over a period of time selected by the user (e.g., one month or year) from most energy consumed to least energy consumed relative to each other, and (ii) average efficiency of each appliance relative to an expected average (e.g., according to data provided by a manufacturer of each appliance). A weighed average of the average energy and efficiency may be used to rank the appliances in a vertical search engine.

The search engine may be operable to utilize one of a plurality of advertising strategies (e.g., replacement appliances available in a geographic area that is the same as that of the user) to incentivize the user to replace appliances ranking low on the vertical search engine (i.e., appliances that are operating less efficiently than the expected average).

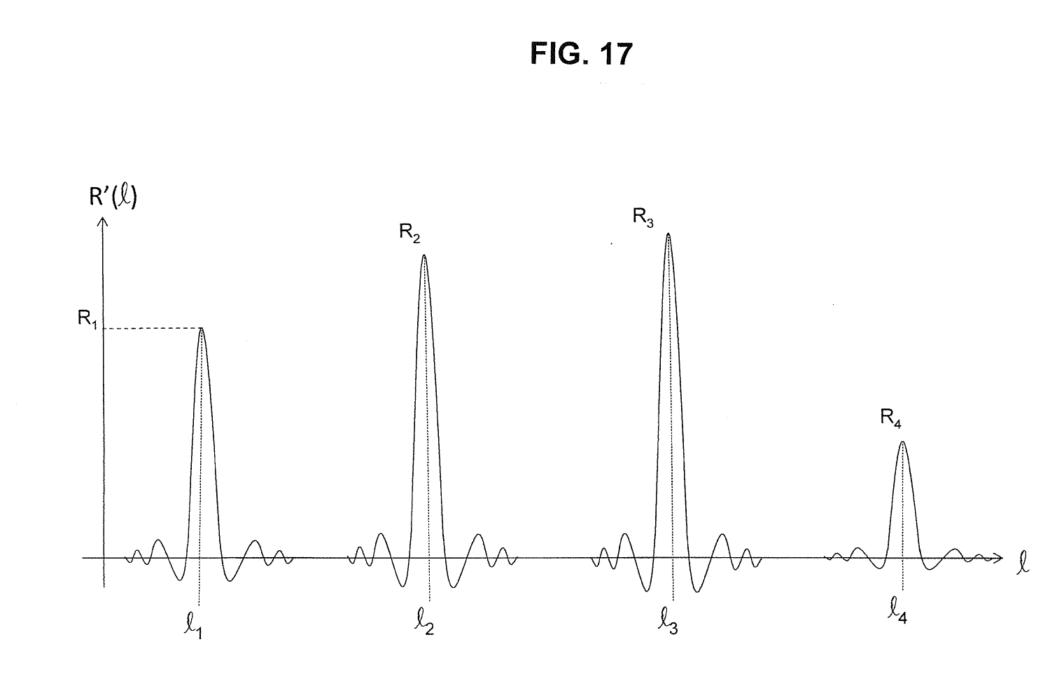

With regard to FIG. 16, as previously discussed, the present inventive concept is operable to measure and obtain a reflection coefficient. In the exemplary embodiment, the present inventive concept measures the reflection coefficient over 917 frequencies, between one and thirty MHz. FIG. 16 illustrates a plot of such a measurement that is made via the VNA. Impedance of the measured reflection coefficient is then determined using the inverse Fast Fourier Transform (FFT) of the reflection coefficient data. In this manner, the impedance is provided as a function of distance, as illustrated by FIG. 17.

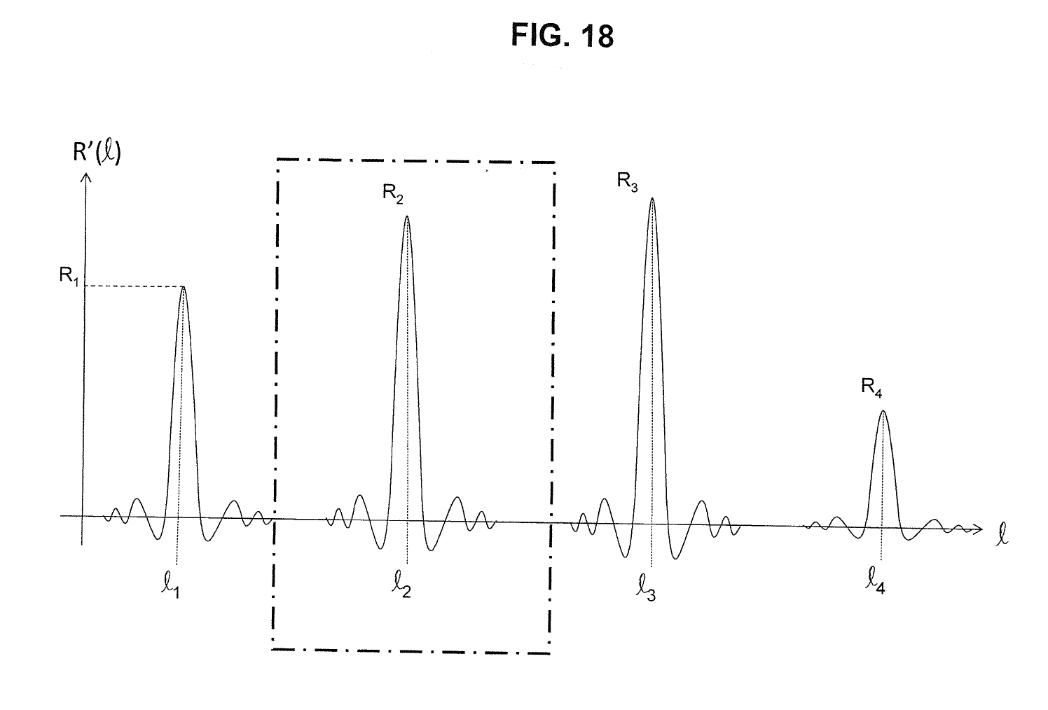

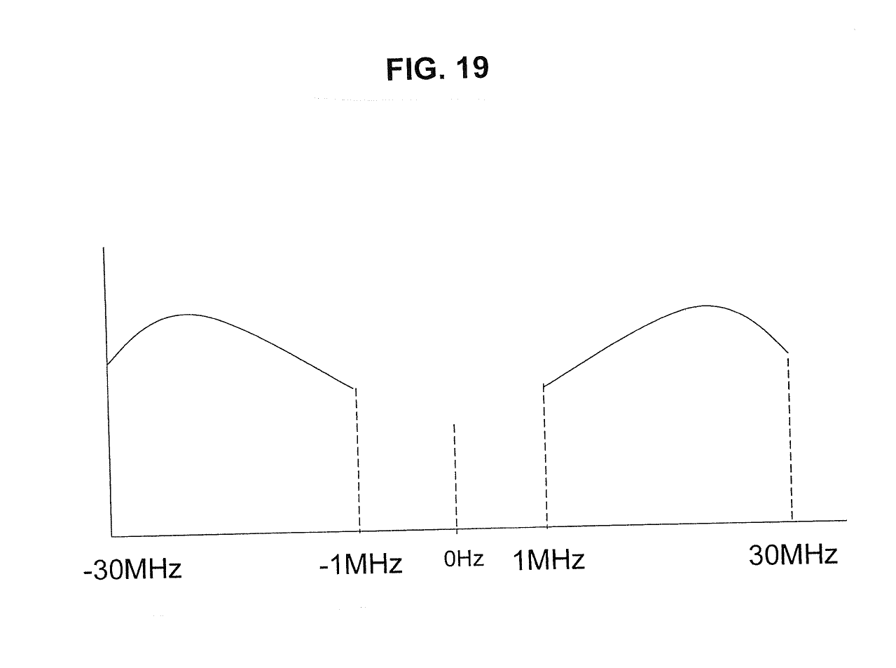

With regard to FIG. 18, the present inventive concept then processes the impedance to remove spurious data produced from multiple reflections and a corrected curve with effects of any scattering eliminated via the processor. Each pulse represents an appliance at a different distance from the present inventive concept (e.g., the meter or controller). Each of the pulses are then separated from each other via the processor and translated to a zero distance from the present inventive concept and then transformed back into the frequency domain using FFT. In this manner, a resultant waveform corresponds to the impedance in the frequency domain that would be accurate right at the appliance (i.e., at a zero distance from each appliance). FIG. 19 is a plot illustrating impedance at a frequency domain of one appliance.

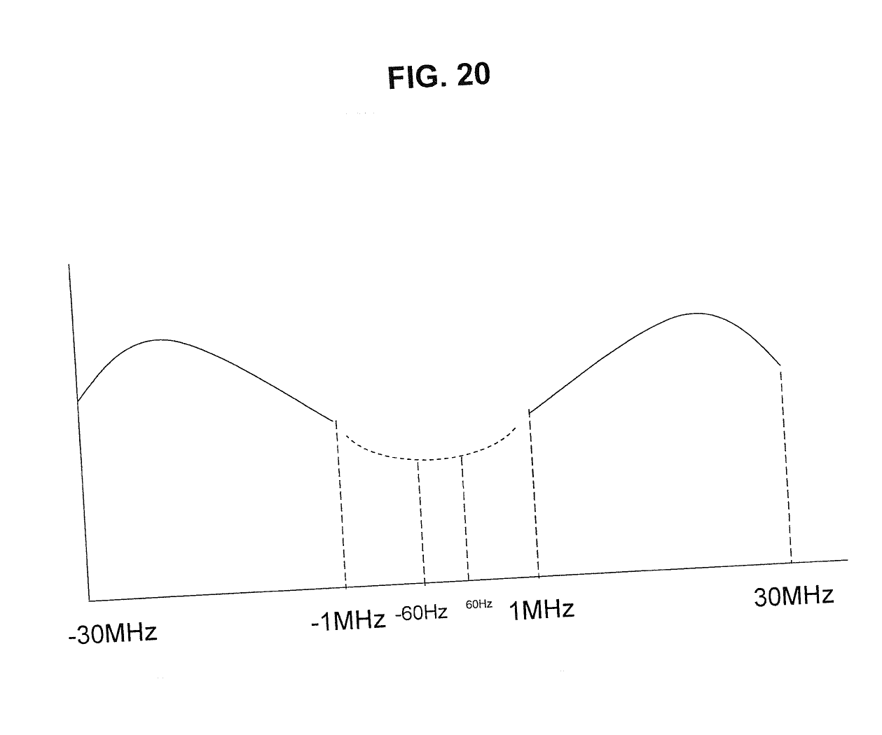

With regard to FIG. 20, a plot illustrating the impedance of FIG. 19 extrapolated down via the processor using a rational function or other standard method for mathematical standard for extrapolation to arrive at Z(60 Hz) is illustrated. The processor is operable to then calculate power used for each appliance, which is provided using the formula:

P=(|Vrms|2/|Z|2)×(R)

Q=(|Vrms|2/|Z|2)×(X)

Z=R+XJ

Power Factor (PF)=R/|Z|

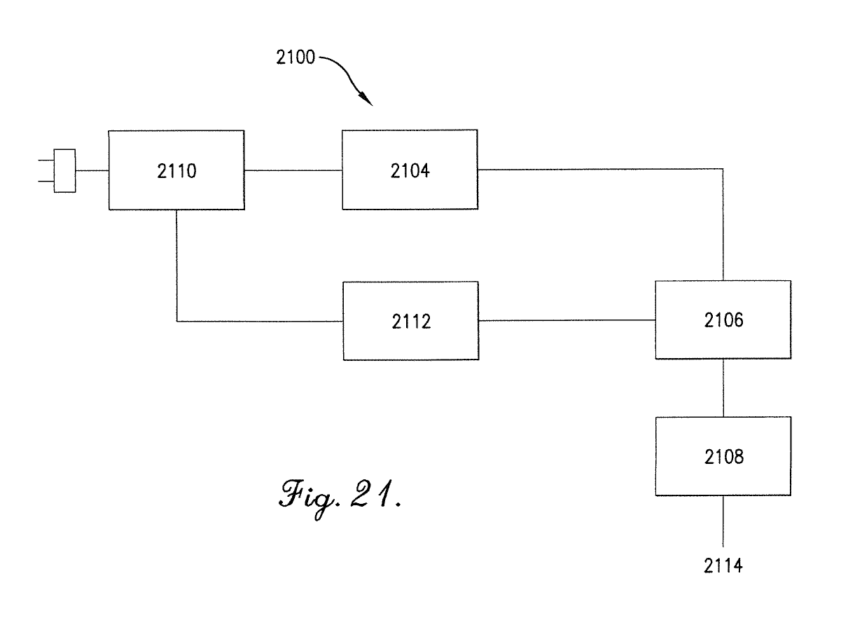

FIG. 21 illustrates an embodiment of the present inventive concept having a network system 2100 for measuring and processing a reflection coefficient as disclosed herein. A VNA 2104 is provided in communication with a microprocessor 2106. The network 2100, as illustrated, includes a controller 2108, which may be an IEEE 802.3/802.11 I/O controller, to communicate with and/or control the network 2100 (e.g., via the microprocessor). An isolation circuit 2110 and a Vrms circuit 2112 may also be included in the network 2100. The controller 2108 may be in communication with a router 2114.

Although it is foreseen that various methods of determine complex impedance of multiple loads may be utilized to achieve the objectives of the present inventive concept, as will be apparent from the present disclosure, the exemplary method is as follows. Particularly, an exemplary method for finding a complex impedance of multiple loads on a transmission line from an array of reflection coefficients measured at different frequencies is provided as follows.

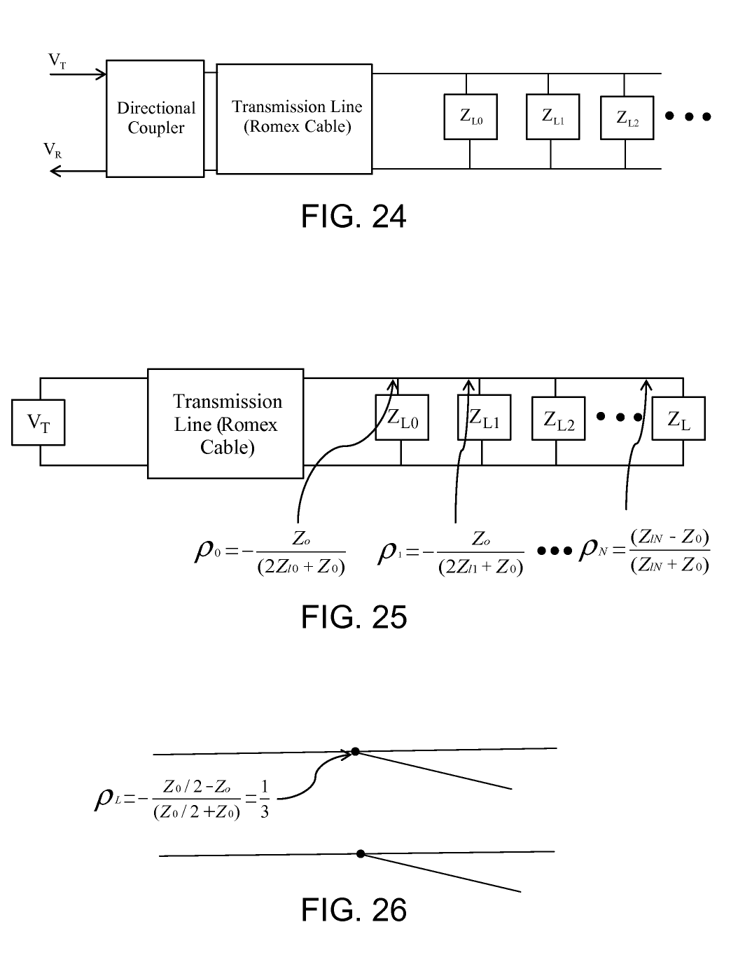

A frequency domain reflectometer or FDR is provided and is operable to scan one or more frequencies over a measurement bandwidth with a predetermined or specific step size by transmitting a sine wave signal whose frequency steps over the given range. A recorder is provided and is operable to record the signals reflected by the transmitted sine wave. The step size is a parameter that is operable to be varied so that various degrees of frequency resolution may be obtained. For example, the present inventive concept utilizes a step size of approximately 25 kHz with a bandwidth of 1 MHz to 30 MHz, which yields about 1000 frequency steps. In this manner, the present inventive concept is operable to accommodate various bandwidths that are common within a residence, that is, generally between 1 to 120 MHz. A formula in view of these parameters is provided in FIG. 24 wherein a number of loads (L) are plugged into a transmission line. Each load impedance is denoted by Z_{Ln} (n=1, 2, 3 . . . ) and the characteristic impedance of the transmission line (such as the Romex Cable) is denoted by Z₀.

If the Applied voltage is V_{T}e^{-jwt}, then the reflected voltage from a single load is given by the following expression, where ‘T₁’ is the round trip time to the load Z_{L1}.

V_{R}=ρ₁V_{T}e^{-jw(t-T}^{₁}⁾

The reflection coefficient corresponding to the Tth load at a given frequency ρᵢ(w) can be computed as follows.

$${ρ}_{i} ( w ) = \frac{{V}_{reflected}}{{V}_{transmitted}} = \frac{{V}_{T} {ρ}_{i} {e}^{( - j w ( t - Ti )}}{{V}_{T} {e}^{( - j wt )}} = {ρ}_{i} {e}^{j w {T}_{i}}$$

If there are multiple (L) loads connected to the transmission line, the above equation could be modified as follows, where Tᵢ, i=1 . . . L is the round trip delay time to the ‘i’th load.

ρ_{L}(w)=ρ₁e^{jwT}^{₁}+ρ₂e^{jwT}^{₂} . . . +ρ_{L}e^{jwT}^{_{L}}

Depending on the frequency w₁ to w_{N}(N>L), a set of values of the reflection coefficients ρs corresponding to the set of frequencies are obtained. In other words, the frequency domain measurements are sampled at ‘N’ frequencies given by w₁, w₂, . . . , w_{N} and the transmission line is sampled at times T₁, T₂, . . . Tₘ (M<N). Each time ‘Ti’ can be translated to its equivalent distance di whose relationship with Ti is given by di=c·Ti, where c=speed of light in the transmission line (generally in a Romex cable, the speed of light can be assumed to be 2×10⁸ m/s). The exemplary embodiment utilizes a time sample spacing Tᵢ₊₁−Tᵢ corresponding to one foot, which can be expressed as follows.

$$N ↕ {( \begin{matrix}ρ ( {w}_{1} ) \\ ρ ( {w}_{2} ) \\ ρ ( {w}_{3} ) \\ ⋮ \\ ρ ( {w}_{N} )\end{matrix} ) = ( \begin{matrix}{e}^{j {w}_{1} {T}_{1}} \\ {e}^{j {w}_{2} {T}_{1}} \\ {e}^{j {w}_{3} {T}_{1}} \\ ⋮ \\ {e}^{j {w}_{N} {T}_{1}}\end{matrix} ) {ρ}_{1} + ( \begin{matrix}{e}^{j {w}_{1} {T}_{2}} \\ {e}^{j {w}_{2} {T}_{2}} \\ {e}^{j {w}_{3} {T}_{2}} \\ ⋮ \\ {e}^{j {w}_{N} {T}_{2}}\end{matrix} ) {ρ}_{2} + … + ( \begin{matrix}{e}^{j {w}_{1} {T}_{M}} \\ {e}^{j {w}_{2} {T}_{M}} \\ {e}^{j {w}_{3} {T}_{M}} \\ ⋮ \\ {e}^{j {w}_{N} {T}_{M}}\end{matrix} )}^{{↔}^{M}} {ρ}_{M} + ( \begin{matrix}{ξ}_{1} \\ {ξ}_{2} \\ {ξ}_{3} \\ ⋮ \\ {ξ}_{N}\end{matrix} )$$

This relation can also be expressed as follows without deviating from the scope of the present inventive concept.

$$Y = ( \begin{matrix}ρ ( {w}_{1} ) \\ ρ ( {w}_{2} ) \\ ρ ( {w}_{3} ) \\ ⋮ \\ ρ ( {w}_{N} )\end{matrix} ) = ( \begin{matrix}{e}^{j {w}_{1} {T}_{1}} & … & {e}^{j {w}_{1} {T}_{M}} \\ ⋮ & ⋱ & ⋮ \\ {e}^{j {w}_{M} {T}_{1}} & … & {e}^{j {w}_{M} {T}_{M}} \\ ⋮ & ⋱ & ⋮ \\ {e}^{j {w}_{N} {T}_{1}} & … & {e}^{j {w}_{N} {T}_{M}}\end{matrix} ) ( \begin{matrix}{ρ}_{1} \\ {ρ}_{2} \\ {ρ}_{3} \\ ⋮ \\ {ρ}_{M}\end{matrix} ) + ( \begin{matrix}{ξ}_{1} \\ {ξ}_{2} \\ {ξ}_{3} \\ ⋮ \\ {ξ}_{N}\end{matrix} ) = AX + ξ \qquad ( 1 )$$

The reflection coefficients at every point on the transmission line (the vector X) are found by minimizing at least one aspect of the norm of the error ε, for example, via the least squares approximation or by minimizing another norm of the error. Alternatively, it is foreseen that the problem may be formulated as a nonlinear least squares problem. It has been discovered, however, that the linear formulation provides adequate results. The Ti's are discretized to a fine grid. In the algorithm mentioned hereafter, Ti's are calculated or taken at every foot of the Romex cable. To solve the system of equations, there are ‘M’ unknowns and ‘N’ different equations. The array X may be assumed to be sparse with ‘L’ loads being nonzero. Thus, the aforementioned problem may be modeled as a linear programming problem or any other optimization problem or the like, which could then easily account or otherwise allow for any constraints. By solving for the system of equations, the vector X is computed. This essentially contains the ‘ρ’s corresponding to the various loads. It has been found that the linear least squares are the preferred implementation. It should be noted, however, that when N=M and uniform frequency is used, the matric A is the DFT matrix and the least squares is the equivalent to taking the inverse DFY of the measured data. This exposition provides several advantageous features over the conventional methods including, but not limited to, enabling mitigation of the effects of reverberation by accounting for them within the step of transforming from frequency domain to the time-space domain.

In regards to determining a reflection coefficient, the basic formula for calculation of reflection coefficient for any load L is given by

$${ρ}_{L} = \frac{( {Z}_{L} - {Z}_{o} )}{( {Z}_{L} + {Z}_{0} )} \qquad ( 2 )$$

There are two different expressions for the reflection coefficient that need to be computed, that is, a first one for an end load, which is located at the end of the transmission line, and a second one for one or more loads that are not located at the end of the line, e.g., in between the first and second ends of the line or at intermediate positions. As the wave travels along the transmission line, the wave is subjected to or sees an impedance Z_{L}∥Z₀ for loads plugged in at intermediate positions as opposed to Z_{L} for the load at the very end of the transmission line. As such, the expressions used by the present inventive concept to convert the reflection coefficients found from the least squares into the Load impedances are different with respect to loads at the end of the transmission line and loads at intermediate positions. Such is illustrated in FIG. 25.

Effectively, the following expressions result.

$${ρ}_{L} = \frac{{Z}_{L}^{*} - {Z}_{o}}{( {Z}_{L}^{*} + {Z}_{0} )}$$

$${ρ}_{L} = \frac{{Z}_{L} ‖ {Z}_{0} - {Z}_{o}}{( {Z}_{L} ‖ {Z}_{0} + {Z}_{0} )}$$

Thus, for any load not at the end of the transmission line, the reflection coefficient is given by the following expression.

$${ρ}_{L} = - \frac{{Z}_{o}}{( 2 {Z}_{L} + {Z}_{0} )}$$

Once the reflection coefficients corresponding to the individual loads are computed, the load impedance may be obtained by utilizing the following inverse relation.

$${Z}_{L} = - \frac{{Z}_{0}}{2 {ρ}_{L}} - \frac{{Z}_{0}}{2}$$

For any given load at the end of the line, the reflection coefficient may be obtained by the following expression.

$${ρ}_{L} = \frac{{Z}_{L} - {Z}_{o}}{( {Z}_{L} + {Z}_{0} )}$$

The load impedance for loads at the end of the line can be similarly computed by the following inverse relation.

$${Z}_{L} = \frac{{Z}_{0} ( 1 + {ρ}_{L} )}{( 1 - {ρ}_{L} )}$$

The appliance plugged into or otherwise pulling energy from the transmission line is modeled as parallel or series combination of resistors (R), capacitors (C) and inductors (L). For parallel RLC, RL, RC and R circuit models the real part of the impedance is constant with frequency. For Series RLC, RL, RC and R circuits the conductance is constant with frequency. For most appliances, the real part of the impedance is a constant with frequency. The normalized impedance of a load is given by the following expression.

$${Z}_{L}^{′} = \frac{{Z}_{L}}{{Z}_{0}} = r + jx$$

Because

$${ρ}_{L}^{′} = \frac{{Z}_{{L}^{′}} - 1}{{Z}_{L}^{′} + 1} ,$$

the following expressions are true, where ρᵣ and ρᵢ are the real and imaginary components of the reflection coefficient ρ.

$$r = \frac{1 - {ρ}_{r}^{2} - {ρ}_{i}^{2}}{{( 1 - {ρ}_{r} )}^{2} + {ρ}_{i}^{2}}$$

$$x = \frac{2 {ρ}_{i}}{{( 1 - {ρ}_{r} )}^{2} + {ρ}_{i}^{2}}$$

The real part of the normalized impedance r is generally constant with respect to frequency and the imaginary part x varies slowly in the HF range and can be well approximated as a constant for the initial estimate. Thus, the method of the present inventive concept is operable to begin by solving the system of equations for a complex impedance which is constant with frequency. Subsequently, the resistance r is retained and the reactance x is extrapolated from the initial estimate using the fact that it must be zero at zero frequency. The reactance is extrapolated to 60 Hz using a polynomial or similar extrapolation method. The resistance at 60 Hz is taken to be the constant resistance. The resulting complex impedance at 60 Hz is used to calculate the real and reactive power and the power factor for each load.

Regarding channel characteristics, it is important to model the stationary reflections of a particular home wiring network which can be considered as a channel model. For example, Romex Cable is commonly utilized in most home wiring networks. In such cable, any stationary conditions such as, but not limited to, bends, twists, branching, and/or the like affect the channel model. While these conditions do not consume power, they still appear in the calculations and their effects need to be eliminated from the measurements so that they do not adversely affect or otherwise distort the estimates. For example, the expression of FIG. 26 illustrates a split or branch in a transmission line.

At the split or branch, the impedance seen by the wave will be given by (Z₀∥Z₀)=Z₀/2. As such, the effective reflection coefficient will result in a constant, e.g., ⅓. The measured reflection coefficient at each frequency can be expressed as a product of a component of the reflection coefficient due to no load times and/or a component of the reflection coefficient due to loads. The no load reflection coefficient is eliminated by the present inventive concept as follows. It should be noted that the reflection coefficients can be written as the product.

$$ρ ( w ) = \frac{{V}_{ref}}{{V}_{in}} = \frac{{V}_{ref}}{{V}_{refNL}} \cdot \frac{{V}_{refNL}}{{V}_{in}} \\ let \\ \frac{{V}_{ref}}{{V}_{in}} = {ρ}_{measured} , \frac{{V}_{ref}}{{V}_{refNL}} = {ρ}_{load} , \frac{{V}_{refNL}}{{V}_{in}} = {ρ}_{noload} \\ {ρ}_{measured} = {ρ}_{load} \cdot {ρ}_{noload} \\ Taking logarithm on both sides \\ log ( {ρ}_{calc} ) = log ( {ρ}_{load} ) + log ( {ρ}_{noload} ) \\ so , \\ log ( {ρ}_{load} ) = log ( {ρ}_{measured} ) - log ( {ρ}_{noload} ) \qquad ( 3 )$$

Equation (3) defines the calibration step used by the present inventive concept to remove the channel effects. The second term in equation (3) is averaged by the present inventive concept over many measurements so as to obtain a steady average of the reflection coefficient.

Thus the measured reflection coefficient is first corrected by log(ρ_{load})=log(ρ_{measured})−average (log(ρ_{noload})). Antilog is then used to obtain the ρ_{load}′(w), which is used for further processing. Thus, the channel effects of the transmission line is mitigated in the exemplary embodiment by calculating the average of the log of the no load reflection coefficients and subtracting the average from the log of the calculated ρ(w). The long term average of the reflection coefficients of the line represents the overall characteristic of the transmission line considering no loads plugged into the transmission line (channel characteristics). If measurements are taken continuously over time and averaged, they represent the channel of the particular house in consideration. The idea behind this technique is that the bends, twists etc. could be considered as loads and when the reflection coefficient profile of the transmission line is measured considering these discrepancies as loads and then averaged. This average over many runs (M₁) converges to the channel characteristics of the transmission line. Mathematically, such may be expressed as follows, where L₁, L₂ . . . L_{K} denote the various discrepancies on the line.

$${ρ}_{Lavg} ( w ) \frac{( \overline{{ρ}_{nL 1}} {e}^{j {wT}_{1}} + \overline{{ρ}_{nL 2}} {e}^{j {wT}_{2}} … + \overline{{ρ}_{nLK}} {e}^{j {wT}_{K}} )}{{M}_{1}} \qquad ( 4 )$$

As such, the computed ρ(w) is subtracted from the above expression to give a more accurate answer.

Another important process provided by the present inventive concept is reduction of the processing load and comparing current measurements to prior measurements. While measuring impedances, the processing requirements can only be reduced if the change in the reflection coefficient profile of the transmission line changes, e.g., due to loads or appliances being turned on and/or off, or otherwise altered, e.g., due to changes in a washing machine cycle or the like. with respect to the previous measurement is considered. Any change is computed by subtracting every Kth measured value from the (K−1)th value. This calculation can be interpreted as a ‘change detector’ because the value computed would consider the changes in the load impedances and the algorithm could then be utilized to estimate changes in the load impedance value, which is a primary interest of the present inventive concept.

ρ(w)=ρ_{K}(w)ρ_{K-1}(w)

Regarding geometric summation for the reverberation model, the present inventive concept assumes that the transmission line is discretized into a fine grid with presence of Ti's at about every one foot. There are multiple reflections that can be assumed to take place between the source and a particular Ti as well as between two or more Ti's, that is, reverberations. As such, higher order terms, e.g., e^{j2wiTi}, e^{j3wiTi} . . . , are added by the present inventive concept along with the e^{jwiTi} term for each element of the A matrix to yield a more precise estimate. A very simple model for the reverberation has been found to be useful where it is assumed that there are no losses and infinite reflections. Mathematically, such can be written as expressed as follows.

$${e}^{j 2 wiTi} + {e}^{j 2 wiTi} + {e}^{j 2 wiTi} … + ∞ \\ ⇒ {\sum }_{n = 0}^{∞} {e}^{j wiTi} - 1 \\ ⇒ \frac{1}{1 - {e}^{j wiTi}} - 1 \\ ⇒ \frac{{e}^{j wiTi}}{1 - {e}^{j wiTi}} \qquad ( 5 )$$

It has been discovered that the columns of the matrix A, as given by equation (1), provide a better model for the practical case of a transmission line with reverberations by using columns which are sampled versions of

$$\frac{{e}^{j wiTi}}{1 - {e}^{j wiTi}}$$

rather than the original e^{jwiTi}. This is the preferred expression to be used for the column vector of A.

Regarding variation of ρ with frequency, in the aforementioned explanation, ρ was considered to be constant with respect to frequency. However, p for a particular load changes with frequency according to the relation provided as follows, wherein a left portion of the relation is Taylor Series and a right portion of the relation is Skin Effect.

ρ*(w)=ρ₀+ρ₁w+ρ₂w²+ . . . +ρₛ\sqrt{w} (6)

Thereby, in the X vector (from equation (1)), a single value of ρ may be replaced for a particular load by a vector representing the coefficients of w from equation (6). Thus, equation (1) can be modified as provided by the following expression.

$$\begin{matrix}Y = ( \begin{matrix}ρ ( {w}_{1} ) \\ ρ ( {w}_{2} ) \\ ρ ( {w}_{3} ) \\ ⋮ \\ ρ ( {w}_{N} )\end{matrix} ) \\ = ( \begin{matrix}{e}^{j {w}_{1} {T}_{1}} & {w}_{1} {e}^{j {w}_{1} {T}_{1}} & {w}_{1}^{2} {e}^{j {w}_{1} {T}_{1}} & … & {e}^{j {w}_{1} {T}_{M}} \\ ⋮ & ⋮ & ⋮ & ⋱ & ⋮ \\ {e}^{j {w}_{M} {T}_{1}} & {w}_{M} {e}^{j {w}_{M} {T}_{1}} & {w}_{M}^{2} {e}^{j {w}_{M} {T}_{1}} & … & {e}^{j {w}_{M} {T}_{M}} \\ ⋮ & ⋮ & ⋮ & ⋱ & ⋮ \\ {e}^{j {w}_{N} {T}_{1}} & {w}_{N} {e}^{j {w}_{N} {T}_{1}} & {w}_{M}^{2} {e}^{j {w}_{M} {T}_{1}} & … & {e}^{j {w}_{N} {T}_{M}}\end{matrix} ) ( \begin{matrix}{ρ}_{10} \\ {ρ}_{11} \\ {ρ}_{12} \\ ⋮ \\ {ρ}_{20} \\ {ρ}_{21} \\ ⋮ \\ ⋮ \\ {ρ}_{M}\end{matrix} )\end{matrix}$$

In this expression, the terms ρ₁₀, ρ₁₁, . . . represent the coefficients of equation (6) for a particular load with reflection coefficient as ρ1. The present inventive concept incorporated these changes in the matrices after the load positions on the transmission line have been estimated by the algorithm using the previous value of X and A from equation (1) and then the Least squares may be performed again to obtain a better estimate of the reflection coefficient of a particular load. An alternate approach is to incorporate these changes initially before the equation is set up for least squares approximation. However, in this alternative method, the number of calculations increases considerably and so does the complexity of the algorithm.

In an alternate method, when performing Least squares, it is assumed that A is in the frequency domain (function of w) and the equations are processed accordingly. An alternate approach would be to convert the elements of A (from (1)) to the time domain by performing an IDFT on each column of the A matrix. The following is an equivalent expression.

$$idft ( \begin{matrix}ρ ( {w}_{1} ) \\ ρ ( {w}_{2} ) \\ ρ ( {w}_{3} ) \\ ⋮ \\ ρ ( {w}_{N} )\end{matrix} ) = ( idft ( \begin{matrix}{e}^{j {w}_{1} {T}_{1}} \\ ⋮ \\ {e}^{j {w}_{M} {T}_{1}} \\ ⋮ \\ {e}^{j {w}_{N} {T}_{1}}\end{matrix} ) … idft ( \begin{matrix}{e}^{j {w}_{1} {T}_{M}} \\ ⋮ \\ {e}^{j {w}_{M} {T}_{M}} \\ ⋮ \\ {e}^{j {w}_{N} {T}_{M}}\end{matrix} ) ) ( \begin{matrix}{ρ}_{1} \\ {ρ}_{2} \\ {ρ}_{3} \\ ⋮ \\ {ρ}_{M}\end{matrix} ) + ( \begin{matrix}{ξ}_{1} \\ {ξ}_{2} \\ {ξ}_{3} \\ ⋮ \\ {ξ}_{N}\end{matrix} )$$

Note that the columns could be the Fourier transform of the quantities measured in the frequency domain and transformed into the time-space domain or they could be measured directly in the time domain. In the latter case this formulation would correspond to how the new invention can be used with a time domain reflectometer measurement front end whereas the previous description applied to a frequency domain reflectometer measurement. Either case may be transformed into the other. The conventional DFT approach does not account for reverberation, so a preferred method has been discovered which accounts for this phenomenon. The preferred column vectors use the geometric progression summation term rather than using just the exponent.

$$idft ( \begin{matrix}ρ ( {w}_{1} ) \\ ρ ( {w}_{2} ) \\ ρ ( {w}_{3} ) \\ ⋮ \\ ρ ( {w}_{N} )\end{matrix} ) = ( idft ( \begin{matrix}\frac{{e}^{j w 1 {T}_{1}}}{1 - {e}^{j w 1 {T}_{1}}} \\ ⋮ \\ \frac{{e}^{j {w}_{M} {T}_{1}}}{1 - {e}^{j {w}_{M} {T}_{1}}} \\ ⋮ \\ \frac{{e}^{j {w}_{N} {T}_{1}}}{1 - {e}^{j {w}_{N} {T}_{1}}}\end{matrix} ) … idft ( \begin{matrix}\frac{{e}^{j {w}_{1} {T}_{M}}}{1 - {e}^{j {w}_{1} {T}_{M}}} \\ ⋮ \\ \frac{{e}^{j {w}_{M} {T}_{M}}}{1 - {e}^{j {w}_{M} {T}_{M}}} \\ ⋮ \\ \frac{{e}^{j {w}_{N} {T}_{M}}}{1 - {e}^{j {w}_{N} {T}_{M}}}\end{matrix} ) ) ( \begin{matrix}{ρ}_{1} \\ {ρ}_{2} \\ {ρ}_{3} \\ ⋮ \\ {ρ}_{M}\end{matrix} ) + ( \begin{matrix}{ξ}_{1} \\ {ξ}_{2} \\ {ξ}_{3} \\ ⋮ \\ {ξ}_{N}\end{matrix} )$$

In an algorithm of the exemplary embodiment of the present inventive concept, frequency measurements are performed over any range, for example, 1 MHz-30 MHz in steps of 25 Khz khz., which are values in the time domain. It is desirable to start the calculation with 1 MHz and obtain the DFT vector for the frequency step value via the following operation.

D(i)=e^{-j2πf/N[1, 2 . . . , N-1]}

The dot product of D(i) is then calculated with the samples extracted at 1 Mhz with the corresponding loads plugged in to the transmission line, e.g., the Romex cable, which yields a single value that provides the value of the reflection coefficient corresponding to the frequency, i.e., “load line array.” Similar dot products may be computed for value for channel line, which represents the average reflection coefficient of the Romex cable at that frequency with no loads connected as calculated by (4). Both of these values are then normalized. The aforementioned steps may be repeated by the present inventive concept for all frequency increments.

At the end of all iterations, ρ_{load} and ρ_{noload} (for different frequency steps) are obtained by the present inventive concept. Both the arrays are multiplied by a 1−e^{(jwt)} term, which compensates for the denominator of the Geometric progression sum, as previously discussed. To convert these arrays into the time domain, the inverse fast fourier transform is performed by the present inventive concept. Note that to obtain real values while computing IFFT in MATLAB, it is necessary to zero pad the array so that the array size reaches the nearest power of two and also to ensure complex conjugate symmetry. Cesptrum IFFT may be obtained by subtracting log of the channel IFFT from the log of the load IFFT.

After acquiring the cepstrum IFFT (Inverse Fast Fourier Transform), the present inventive concept acquires the reflection coefficients for the given load. This is accomplished by modeling the cepstrum ifft via a series of equations that produce an output time domain waveform that approximates the cepstrum ifft. The equation may be modeled as a linear algebra problem:=, e.g., Y=AX, where vector Y is the first ‘M’ time domain values of the cepstrum ifft.

A is a series of columns that model the first ‘M’ time domain values from an ifft of equation, where f is the frequency range of 1 MHz to 30 MHz in 25 kHz steps and ‘Ti’ is the amount of time required for a pulse to travel a given number of feet.

$$\frac{{e}^{j 2 π f ( Ti )}}{1 - {e}^{j 2 π f ( Ti )}}$$

The columns range from 1 ft-59 ft, which is the length of the Romex cable being used. It is foreseen that the Romex cable may be of any length and/or range and utilized in the columns, however, without deviating from the scope of the present inventive concept. Vector X contains the reflection coefficients for each one foot position along the transmission line. The values for Y and A are already known, but the vector X of reflection coefficients will need to be calculated. The objective of the present inventive concept is to calculate reflection coefficients so that the error between the actual cepstrum values and the computed ones is minimized. The SNR for the program of the present inventive concept is approximately 15-20 dB in comparison of the signal energy with that of the error energy, i.e., “noise power.” The method to minimize the errors is the least squares method that computes the vector X according to the formula: X=(A^{T}A)⁻¹A^{T}Y.

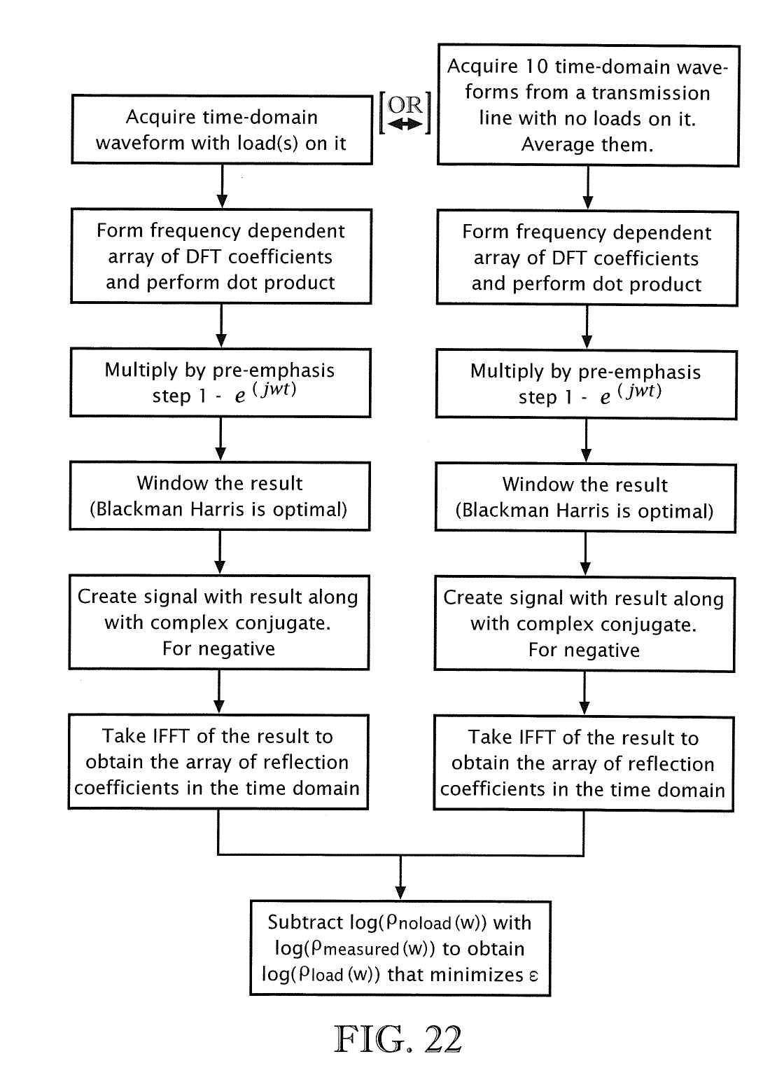

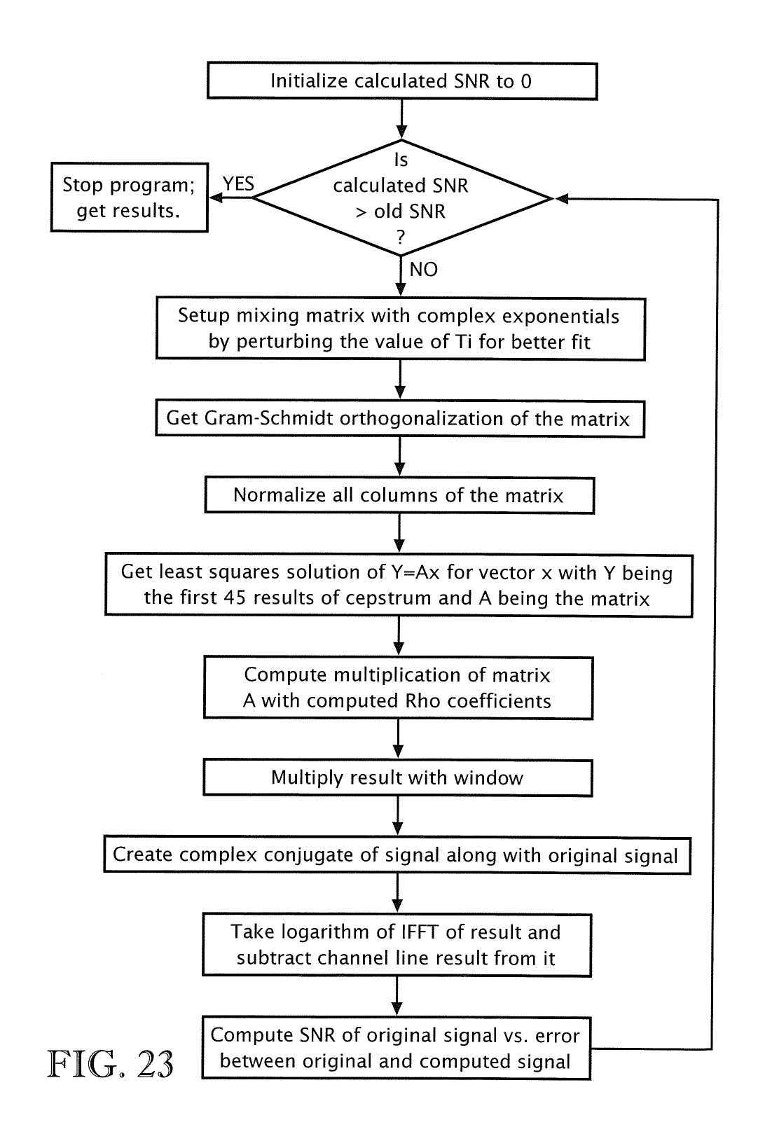

The following steps below details the method used by the present inventive concept to setup the least squares method, as illustrated in FIGS. 22 and 23. It is foreseen that the method may be performed by a controller, such as, but not limited to the controller 2108, and/or a processor, such as but not limited to the microprocessor 2106 without deviating from the scope of the present inventive concept.

1) The vector Y is made to be equal to the first ‘M’ values of the time domain cepstrum values.

2) The present inventive concept assumes that there are an infinite number of reflections taking place at each foot in the Romex cable. As such, each row in the A matrix may be approximated by the sum of a geometric series having the common multiplication term given by e^{j2πf(Ti)} (from (5)), whereby the sum of a geometric series of this kind is given by

$$\frac{{e}^{j 2 π f ( Ti )}}{1 - {e}^{j 2 π f ( Ti )}}$$

which corresponds to each row of the A matrix.

The matrix A is setup by computing the following equation, with Ti=3.0489*10̂−9 seconds per foot and f being frequencies from 1 MHz to 30 MHz in 25 kHz steps.

$$\frac{{e}^{j 2 π f ( Ti )}}{1 - {e}^{j 2 π f ( Ti )}}$$

A vector is created that contains these values along with the conjugate symmetry of them. The IFFT is taken to get the first ‘M’ values for a column in matrix A. The row values are preferably from 1 ft to 59 ft in one foot increments. It is foreseen, however, that any row values and/or any incremental measurement may be used without deviating from the scope of the present inventive concept. The present inventive concept assumes that there is a possible load at every foot along the transmission line. As such, there are more unknowns than equations or measurements. Because the solution is sparse, i.e., mostly zeros, the present inventive concept models this problem as a linear programming model. An alternate method may be used to solve using nonlinear least squares approximation. If the Ti metric and the compensation term used by the present inventive concept for the multiplication of the frequency line array and the channel line array are unknown, the present inventive concept considers it as a non-linear system of equations.

3) Before doing the least squares calculation, a Gram-Schmidt orthogonalization is performed by the present inventive concept, which makes all vectors in the A matrix orthogonal to each other. In this manner, projections in other columns of the matrix are eliminated and interference of the projection in the columns in calculating the reflection coefficients is reduced. The algorithm for the Gram-Schmidt process utilized by the present inventive concept is expressed as follows, where v₁ is the first column in matrix A with v₂, v₃, . . . containing the column number of matrix A.

$$\begin{matrix}{u}_{1} = {v}_{1} , & {e}_{1} = \frac{{u}_{1}}{‖ {u}_{1} ‖} \\ {u}_{2} = {v}_{2} - {proj}_{u 1} ( {v}_{2} ) , & {e}_{2} = \frac{{u}_{2}}{‖ {u}_{2} ‖} \\ {u}_{3} = {v}_{3} - {proj}_{u 1} ( {v}_{3} ) - {proj}_{u 2} ( {v}_{3} ) , & {e}_{3} = \frac{{u}_{3}}{‖ {u}_{3} ‖} \\ {u}_{4} = {v}_{4} - {proj}_{u 1} ( {v}_{4} ) - {proj}_{u 2} ( {v}_{4} ) - {proj}_{u 3} ( {v}_{4} ) , & {e}_{4} = \frac{{u}_{4}}{‖ {u}_{4} ‖} \\ ⋮ & ⋮ \\ {u}_{k} = {v}_{k} - {\sum }_{j = 1}^{k - 1} {proj}_{uj} ( {v}_{k} ) , & {e}_{k} = \frac{{u}_{k}}{‖ {u}_{k} \vert} .\end{matrix}$$

After the orthogonal columns are calculated by the present inventive concept, such are normalized to obtain orthonormal matrices.

4) The present inventive concept performs the least squares approximation by taking the pseudoinverse of the orthonormalized matrix of A, and then multiplying the pseudoinverse with vector Y to obtain the vector X of reflection coefficients.

5) The present inventive concept creates the calculated version of the cepstrum graph by multiplying the reflection coefficient at the given distance with the corresponding exponential equation. The present inventive concept then adds all of the exponential equations to create the frequency domain simulation of the calculated cepstrum graph.

6) The present inventive concept overlays the result from (5) by multiplying the calculated frequency spectrum with the equation 1−e^{j2πf(Ti)}, where f is the frequency range 1 MHz-30 Mhz in 25 kHz steps and ‘Ti’ represents the time it takes to reach a given load at a certain distance away. The frequency spectrum is multiplied by these equations reflecting where all the loads are along the transmission line.

7) The present inventive concept multiplies the result from (6) with a given window that aids in the suppression of insignificant side frequencies while maintaining critical center frequencies, which is preferably Blackman Harris.

8) The present inventive concept creates a vector that includes the value from (7) along with its conjugate symmetry and plots the IFFT of this vector and takes its logarithm. The present inventive concept then subtracts the log of the channel line value from the plot to obtain the predicted cepstrum graph.

9) The present inventive concept calculates the SNR by taking the sum of squares of the first 60 points of the actual cepstrum graph and dividing it by the sum of squares of the difference between the actual and real cepstrum values. The present inventive concept then takes the base 10 logarithm of this and multiplies it by 10.

10) The present inventive concept takes the frequency spectrum of the cepstrum calculations and that of the predicted waveform. The present inventive concept then takes the absolute values of both of them and divides the maximum found in the predicted waveform with that of the actual line. The present inventive concept then multiplies the actual frequency spectrum, i.e., the one measured, with this factor.

11) The present inventive concept again sets up a vector with the values in part (10) along with its conjugate symmetry, takes the IFFT, and gets its logarithm. The present inventive concept then subtracts the log of the channel line time domain waveform from this recalculated spectrum.

12) The present inventive concept repeat steps 1-11 with this new frequency spectrum until the calculated SNR begins dropping. The calculated SNR will be the SNR of the program and the predicted waveform will be the most optimal to compare against the actual cepstrum waveform.

To calculate the resistance, at the first iteration of this program, The present inventive concept takes the Gram-Schmidt orthogonalization of matrix A, but without normalizing the columns. The present inventive concept then computes the vector of reflection coefficients using the least squares method. The present inventive concept then plugs in the reflection coefficient that corresponds to the distance at where the load is to a formula expressed as follows.

$${Z}_{L} = - \frac{{Z}_{0}}{2 {ρ}_{L}} - \frac{{Z}_{0}}{2}$$

If it is identified as a load at the end of the line, the present inventive concept utilizes an equation expressed as follows.

$${Z}_{L} = \frac{{Z}_{0} ( 1 + {ρ}_{L} )}{( 1 - {ρ}_{L} )}$$

The methods and systems described herein may be embodied as computer readable codes on a computer readable recording medium and/or be deployed in part or in whole through a machine that executes computer software, program codes, and/or instructions on a processor. The processor may be part of a server, computing device, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a read-only memory (ROM), random-access memory (RAM), CD-ROMS, magnetic tapes, floppy disks, optical storage devices, and carrier waves, such as data transmission via the internet. The computer readable recording medium may also be distributed over network-coupled computer systems so that the computer readable code is stored and executed in a distribution fashion. Various embodiments of the present inventive concept may also be embodied in hardware, software or in a combination of hardware and software.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music users and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and processes described herein, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes or functions may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

For example, any of the computers, memories, or processors described herein, such as but not limited to the processing unit 802, memory 808, user interface 814, and browser interface 1300, 1400, 1500, and/or functions thereof may be embodied in software, in hardware or in a combination thereof. For instance, any of the expressions, formulas, and/or other calculations described herein may be embodied as computer readable codes on a computer readable recording medium and/or may be processed to yield one or more results by any of the computers, memories, or processors described herein. The terms “program,” “method,” “expression,” “formula,” and “calculation,” as used herein, are intended to be synonymous to each other irrespective of whether the use is singular or plural. In various embodiments, the processing unit 802, memory 808, user interface 814, and browser interface 1300, 1400, 1500 and/or functions thereof may be embodied as computer readable codes on a computer readable recording medium to perform tasks such as file and/or data transmission and/or reception operations, such as those illustrated in FIGS. 8-12. Further, the processing unit 802, memory 808, user interface 814, and browser interface 1300, 1400, 1500 and/or functions thereof may be embodied as computer readable codes on a computer readable recording medium to perform tasks such as displaying and/or printing operations, such as the data displaying and printing operations illustrated in FIGS. 13-15.

The previous detailed description is of a small number of embodiments for implementing the invention and is not intended to be limiting in scope. One of skill in this art will immediately envisage the methods and variations used to implement this invention in other areas than those described in detail.

Having now described the features, discoveries and principles of the present inventive concept, the manner in which the present inventive concept is constructed and used, the characteristics of the construction, and advantageous, new and useful results obtained; the new and useful structures, devices, elements, arrangements, parts and combinations, are set forth in the appended claims.

It is to be understood that the following claims are intended to cover all of the generic and specific features of the present inventive concept herein described, and all statements of the scope of the present inventive concept which, as a matter of language, might be said to fall therebetween.

What is claimed:

1. A method to control power usage within a network having an electrical circuit electrically connected to an over-current protection device, said method comprising:
measuring, by a power measurement device electrically connected to the electrical circuit by which a load draws power, an electrical parameter of the electrical circuit;
computing a data value related to power being drawn by the load connected to the electrical circuit using the measured electrical parameter;
comparing the computed data value related to the power being drawn on the electrical circuit with an ideal data value to yield comparison data; and
adjusting power available to be drawn by the load from the electrical circuit if the comparison data indicates that the computed data value is greater than the ideal data value.

2. The method according to claim 1, wherein the step of adjusting power includes communicating a command to an appliance controller to cause the dimmer switch to (i) stop power output to the load from the electrical circuit or (ii) decrease a maximum power output available to be drawn by the load from the electrical circuit to a limited power output.

3. The method according to claim 2, wherein the limited power output causes the data value to be equal to or less than the ideal data value.

4. The method according to claim 1, wherein the computed data value is an efficiency factor of the load and the complex impedance of the load and the ideal data value is a threshold resistance value.

5. The method according to claim 4, wherein the step of adjusting power includes notifying a user that the power factor or efficiency of the load has crossed the threshold resistance value and communicating at least one load replacement option to the user.

6. The method according to claim 1, further comprising the step of:
distinguishing the load from a plurality of other loads by determining each distance of the load and each of the plurality of other loads from the power measurement device.

7. The method according to claim 6, further comprising the step of:
obtaining an impedance profile centered at each distance of the load and each of the plurality of other loads.

8. The method according to claim 7, wherein the profile for the load is translated such that the profile is centered at a distance of zero from the power measurement device to simulate a measurement that is approximate to each load.

9. The method according to claim 7, further comprising the step of:
transforming the profile to a frequency domain via a numeric transformer.

10. The method according to claim 9, further comprising the steps of:
extrapolating impedance frequency data using complex analytic functions; and
calculating power for each load using complex impedance.

11. The method according to claim 1, further comprising the step of:
processing a subsequent waveform and correcting previously-determined impedance values based on a prior waveform.

12. The method according to claim 7, further comprising the step of:
applying inverse filter frequency characteristics of a prior waveform to a subsequent waveform.

13. A device to measure and control power usage within a residence having a plurality of electrical circuits electrically connected to an over-current protection device, said device comprising:
a first circuit configured to generate an alternating current (AC) measurement signal;
a second circuit configured to apply the AC measurement signal onto one of the electrical circuits;
a third circuit configured to measure a plurality of AC voltages in response to said second circuit applying the AC measurement signal onto one of the electrical circuits;
a processing unit in communication with said third circuit, and configured to calculate an impedance of appliances connected to the electrical circuits; and
an input/output unit in communication with said processing unit and configured to communicate data generated by said processing unit to a remote location via a communications network.

14. The device according to claim 13, further comprising:
a switch operable to control a power level transported to one or more of the appliances.

15. The device according to claim 13, wherein said processing unit is further configured to calculate power usage and an efficiency factor based on the calculated impedance of one or more of the appliances.

16. The device according to claim 13, wherein said first circuit, second circuit, third circuit, and processing unit are configured to use reflectometer measurement techniques to measure impedance of one or more of the appliances drawing power from one or more of the electrical circuits.

17. The device according to claim 13, wherein said processing unit is further configured to deactivate or decrease power to one or more of the appliances in the event that a determination is made in which the amount of power being drawn by the one or more of the appliances has crossed a power threshold level.

18. A method to motivate a user to reduce energy use by offering discounts for products or services available from a merchant to the user based on energy use of the user, said method comprising:
monitoring electrical power use in a residence of building of the user over a first time period via an energy monitoring system to yield a baseline energy use of the first time period;
monitoring electrical power use for the residence or building over a second time period;
comparing the electrical power use for the residence or building of the second time period to the baseline energy use of the first time period;
determining if the electrical power use of the residence or building is more or less than the baseline energy use; and
crediting one or more points to the user if the electrical power use of the residence or building is less than the baseline energy use.

19. The method according to claim 18, further comprising the step of:
converting the one or more points to a discount on or monetary credit toward a purchase price of the products or services available from the merchant.

20. The method according to claim 18, further comprising the steps of:
comparing the electrical power use for the residence or building of the second time period to a plurality of individuals in a geographic area that is the same as or different than the geographic area of the user to yield comparison data; and
displaying the comparison data to the user.
